(19) United States
(12) Patent Application Publication
(10) Pub. No.: US 2025/0252240 A1
(43) Pub. Date: Aug. 7, 2025

(54) Data-Driven Discovery of Unconventional Reservoir Physics for Continuous Well Performance Analysis

(71) Applicant: Xecta Intelligent Production Services, Houston, TX (US)

(72) Inventors: Hardikkumar Zalavadia, Houston, TX (US); Sathish Sankaran, Spring, TX (US); Prithvi Singh Chauhan, Bryan, TX (US); Utkarsh Sinha, Houston, TX (US)

(21) Appl. No.: 19/000,313

(22) Filed: Dec. 23, 2024

Related U.S. Application Data
(60) Provisional application No. 63/549,922, filed on Feb. 5, 2024.

(51) Int. Cl. G06F 30/28; E21B 47/003; G06F 113/08

(52) U.S. Cl. CPC G06F 30/28; E21B 47/003; G06F 2113/08

(57) ABSTRACT

A method for determining fluid flow dynamics in a well comprises determining a first set of basis functions that is dependent on time. The method further comprises conducting a sparse identification of nonlinear dynamics (SINDy) evaluation based on the first set of basis functions. The method further comprises determining a rate normalized pressure for a primary phase rate. The method further comprises forecasting the primary phase rate for a plurality of bottomhole pressure measurements. The method further comprises determining a gas oil ratio based on a second set of basis functions that are dependent on both time and bottomhole pressure. The method further comprises calculating a secondary phase rate based on the determined gas oil ratio and the forecasted primary phase rate.

### CROSS-REFERENCE TO RELATED APPLICATIONS

This application claims priority to U.S. Provisional Application No. 63/549,922 filed Feb. 5, 2024 entitled “DATA-DRIVEN DISCOVERY OF UNCONVENTIONAL RESERVOIR PHYSICS FOR CONTINUOUS WELL PERFORMANCE ANALYSIS” by Sathish Sankaran, Hardikkumar Zalavadia, Prithvi Singh Chauhan, and Utkarsh Sinha, which is incorporated herein by reference as if reproduced in its entirety.

### TECHNICAL FIELD

The present disclosure relates to determining estimations of reservoir or well performance characteristics and, more particularly, to methods for estimating fluid flow dynamics in multi-fractured horizontal wells.

### BACKGROUND

Understanding well production performance in hydrocarbon reservoirs in a timely manner is essential for closed loop reservoir management, improving operational efficiency, and maximizing value. As operations extend to more complex reservoirs, the industry is faced with challenges to effectively assess and develop these fields. Early understanding of reservoir performance and mitigating remaining uncertainties are important to earning the maximum possible benefit from the assets. However, there is a lack of robust methods for tracking and detecting well performance for optimal reservoir management. In common practice, well productivity is often evaluated through manual interpretations of planned well events (e.g., shut-ins, well tests, etc.). However, traditional surveillance methods are interpretive and do not scale for manual surveillance of either large fields or wells that have large data volumes.

A need exists for a robust and scalable method for estimating fluid flow dynamics in multi-fractured horizontal wells, which can be applied in a practical and automated manner.

### BRIEF DESCRIPTION OF THE DRAWINGS

FIG. 1 is a schematic of example fractures.

FIG. 2 is a schematic of an example SINDy sparse regression identifying terms.

FIG. 3 is a schematic of an example conceptual model of a vertical well.

FIG. 4 is a schematic of example potential flow regimes in multi-fractured horizontal wells.

FIG. 5 is a schematic of example inter-fracture flow and boundary dominated flow.

FIG. 6 is a schematic of an example complex fracture network.

FIGS. 7A and 7B are a set of plots representing example sub-linear and sub-radial flow regimes.

FIGS. 8A-9B are a set of plots representing example rate normalized pressure predictions.

FIGS. 10A-10D are a set of plots representing example coefficients of the selected basis functions based on the plots of FIGS. 8A-9B.

FIG. 11A is a schematic of an example multi-fractured horizontal well.

FIG. 11B is a plot representing the rate normalized pressure predicted profile associated with the multi-fractured horizontal well of FIG. 11A.

FIGS. 12A-14 are a set of plots associated with the multi-fractured horizontal well of FIG. 11A.

FIG. 15A is a schematic of an example multi-fractured horizontal well.

FIG. 15B is a plot representing the rate normalized pressure predicted profile associated with the multi-fractured horizontal well of FIG. 15A.

FIGS. 16A-17 are a set of plots associated with the multi-fractured horizontal well of FIG. 15A.

FIG. 18 is a plot representing example bottom hole pressure profiles.

FIGS. 19A-19D are a set of plots representing a gas oil ratio forecast profile for a low bottom hole pressure.

FIGS. 20A-20D are a set of plots representing a gas oil ratio forecast profile for a mid-bottom hole pressure.

FIGS. 21A-21D are a set of plots representing a gas oil ratio forecast profile for a high bottom hole pressure.

FIGS. 22A-22B are a set of plots representing a gas rate and bottom hole pressure for a gas well.

FIGS. 23-25C are a set of plots representing gas rate normalized pressure.

FIGS. 26A-26B are a set of plots representing an oil rate and bottom hole pressure for an oil well.

FIGS. 27-29C are a set of plots representing oil rate normalized pressure.

FIGS. 30A-31C are a set of plots representing liquid rate normalized pressure.

FIGS. 32A-35B are a set of plots representing a multiphase forecast over multiple wells.

FIG. 36 is a block diagram showing an example control unit in accordance with certain embodiments of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

Understanding the behavior of fluid flow in unconventional fields has been a widely researched area given the complexity of hydraulic fractures. There may be a growing need to create models to understand performance of hydraulically fractured wells that are scalable across an entire field. Challenges with scalability persist for numerical simulations and rate-transient analysis (“RTA”). Decline curve analysis (“DCA”) and machine learning based methods fall short in capturing certain physical components due to their purely data-driven nature. This may be further exacerbated by lack of availability of operational parameters across several wells. The traditional methods for production forecasting, such as RTA, DCA, and numerical simulation, may struggle to capture the complex physics and operational pace of unconventional reservoirs, resulting in unreliable forecasts. Such methods may not significantly address the varying bottomhole pressure (“BHP”) and nonlinear processes that is often seen in the field. Numerical models can incorporate complex physics but may not be practical for continuous updates and production optimization of thousands of wells daily. The present disclosure herein provides systems and methods addressing said aforementioned problems to discover the physics of flow in multi-fractured horizontal wells (MFHWs) using physics-constrained data-driven methods for pressure and fluid pressure, volume, and temperature (“PVT”) properties for production forecasting from routinely collected data.

The present disclosure relates to systems and methods for estimating reservoir characteristics or well performance characteristics. More specifically, the present disclosure provides a system and method of estimating fluid flow dynamics in MFHWs by determining a rate normalized pressure as a function of a set of time-dependent basis functions then determining an expression for gas oil ratio for an oil well dependent on time and BHP to estimate gas rates. The present disclosure provides a hybrid sparse nonlinear regression (“SNR”) method to capture the process dynamics that are computationally efficient for training and implementation. Complex, non-uniform fractures, and multi-phase flow of fluids do not exhibit diagnostic signatures as planar fractures and single-phase flow, but they exhibit more complex behavior not explained by analytical equations. The hybrid SNR approach may identify the necessary features that control rate-pressure behavior and may forecast a well for various flowing pressures and operating conditions. The method not only captures the natural system dynamics but may also consider the impact of external inputs such as artificial lift and choke, which can be utilized to forecast and manage production scenarios.

Among the many potential advantages to the methods and systems of the present disclosure, only some of which are alluded to herein, the systems and methods of the present disclosure may provide improved methods for estimating fluid flow dynamics in multi-fractured horizontal wells. For example, in certain embodiments, the systems and methods of the present disclosure may use routinely available field data, such as rates and pressures, without making any assumptions about fracture and reservoir flow mechanisms for the estimations. In another example, the systems and methods of the present disclosure may effectively capture fluid flow behavior in complex and non-uniform fractures that exhibit complex diagnostic behavior due to multiple concurrent dynamics that cannot be explained by analytical equations. By utilizing the pressure and time features that explain the phase rates behavior for a given well, the hybrid SNR approach may enable forecasting of the well under different flowing pressure and operating conditions. The proposed systems and methods of the present disclosure may be highly scalable and computationally efficient, making it possible to be applied routinely or at the frequency of available rate data. It does not require manual intervention or human interpretation when applied on a larger scale, thereby reducing interpretation bias. The workflow may be suitable for continuous use, particularly for short-term forecasts. Moreover, as the systems and methods may be automated to run regularly, the forecast accuracy may improve with the availability of more data for unseen flow regimes. Further, the method may be robust because it can be utilized for any well and can be adapted to any level of reservoir complexity as it does not depend on mechanistic fractures or simulation model assumptions. Additionally, the method may allow for the determination of the dominant flow regimes by focusing on the most influential terms instead of basic line fitting procedure.

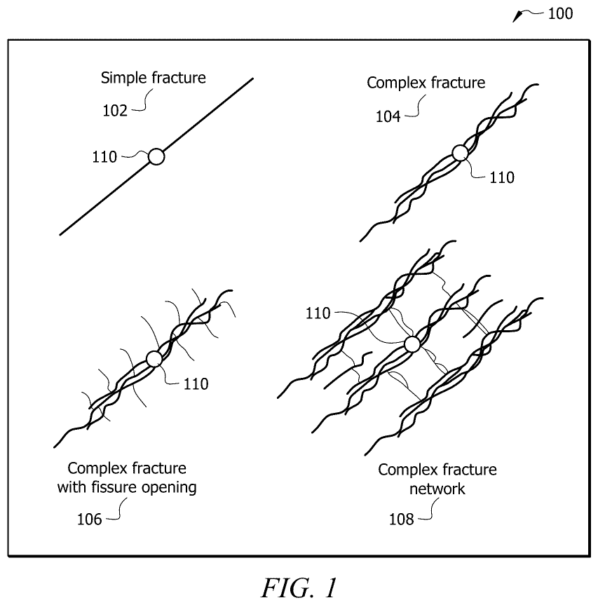

FIG. 1 shows an illustration of various approaches towards characterizing simple to complex fractures. Various hydraulic fracture test site results have highlighted the heterogeneous and complex nature of fractures, which may indicate that there may be multiple dominant fracture systems with different dynamics coexisting and acting concurrently on the well performance. Further, the emergent behavior of the fractures may change from the stage level to segment level and then to the well level. However, the fractured flow behavior may be routinely monitored in unconventional wells using a single lumped flow regime at any instant with classical RTA methods. A method may be determined for coexistence of multiple dynamics that can be computationally simple and scalable.

As illustrated, fractures from simple to complex fractures for an unconventional reservoir 100 may be formed, in accordance with certain embodiments. For example, the development of production of shale gas/shale oil may be made possible through horizontal wells 110 with multiple transverse fractures. In order to optimize the well hydraulic fracturing design for exploration and production, a fracture model may include a plurality of key parameters which characterize a fracture network associated with the unconventional reservoir. In some embodiments, the fracture model may be characterized by various hydraulic fracture test site (HFTS) results which show three types of fracture extensions when intersecting with natural fractures: 1) crossing the natural fractures, 2) extending along the natural fractures, and 3) crossing and extending along at the same time. Based on the fracture extension types formed during a fracturing process of naturally fractured formations, hydraulic fractures may be classified into four major types: 1) a simple fracture 102 including a single bi-wing planar fracture geometry, 2) a complex fracture 104 including multiple fractures, 3) a complex fracture with fissure opening 106 including open natural fractures, and 4) a complex fracture network 108. For example, the complex fracture network 108 may highly form under a low fluid viscosity injection during the fracturing process of naturally fractured formations.

The use of governing equations may be crucial for accurately understanding the performance of unconventional reservoirs. To gain a fundamental understanding of physical processes and extract process dynamics from observed field data, it may be necessary to have accurate models that do not rely on any modeling assumptions. In the case of unconventional operations, time series data, such as rates and pressures, may be available on a daily basis. The present disclosure provides an approach combining data-driven and physics-inspired basis functions with a hybrid sparse non-linear regression SNR method. The proposed hybrid SNR method may consider well operating conditions using changes in BHP and may uncover fluid flow physics in horizontal multi-fractured unconventional reservoirs using routinely available field data, such as rates and pressures, without making any assumptions about fracture and reservoir flow mechanisms.

### Sparse Nonlinear Regression Using SINDy

Regression-based sparse identification of nonlinear dynamics (SINDy) may be a method that integrates sparsity-promoting methods and machine learning with nonlinear dynamical systems to discover governing physical equations based solely on measurements. SINDy may be used to discover fluid flow behavior in MFHWs in unconventional reservoirs by establishing relationships between rates and pressure using only data. The generalized SINDy algorithm starts from the following simple formulation:

$$\frac{d}{dt} x ( t ) = f ( x ( t ) ) \qquad ( 1 )$$

The vector represents the state of the system at time t: (x(t)=[x₁(t), x₂(t), . . . , xₙ(t)]^{T} ∈Rⁿ, and the right-hand side nonlinear function ƒ(x(t)) describes the equation governing the evolution of the dynamical system. In the SINDy formulation, the assumption may be that the nonlinear function ƒ(x(t)) contains only a few terms, which may result in sparse governing equations in high-dimensional nonlinear systems. This assumption may hold true for many physical systems, and this concept of parsimony may be favorable. These algorithms may determine the right-hand side terms that are active in the regression library. To determine the form of the nonlinear function ƒ purely based on data, time-series measurements of the state x(t) and their derivatives with respect to time may be collected.

$$\begin{matrix}X = [ \begin{matrix}{x}^{T} ( {t}_{1} ) \\ {x}^{T} ( {t}_{2} ) \\ ⋮ \\ {x}^{T} ( {t}_{m} )\end{matrix} ] = {\vec{[ \begin{matrix}{x}_{1} ( {t}_{1} ) & {x}_{2} ( {t}_{1} ) & ⋯ & {x}_{n} ( {t}_{1} ) \\ {x}_{1} ( {t}_{2} ) & {x}_{2} ( {t}_{2} ) & ⋯ & {x}_{n} ( {t}_{2} ) \\ ⋮ & ⋮ & ⋱ & ⋮ \\ {x}_{1} ( {t}_{m} ) & {x}_{2} ( {t}_{m} ) & ⋯ & {x}_{n} ( {t}_{m} )\end{matrix} ]}}^{state} ↓ time \\ \dot{X} = [ \begin{matrix}{\dot{x}}^{T} ( {t}_{1} ) \\ {\dot{x}}^{T} ( {t}_{2} ) \\ {\dot{x}}^{T} ( {t}_{m} )\end{matrix} ] = [ \begin{matrix}{\dot{x}}_{1} ( {t}_{1} ) & {\dot{x}}_{2} ( {t}_{1} ) & ⋯ & {\dot{x}}_{n} ( {t}_{1} ) \\ {\dot{x}}_{1} ( {t}_{2} ) & {\dot{x}}_{2} ( {t}_{2} ) & ⋯ & {\dot{x}}_{n} ( {t}_{2} ) \\ ⋮ & ⋮ & ⋱ & ⋮ \\ {\dot{x}}_{1} ( {t}_{m} ) & {\dot{x}}_{2} ( {t}_{m} ) & ⋯ & {\dot{x}}_{n} ( {t}_{m} )\end{matrix} ] .\end{matrix} \qquad ( 2 )$$

Next, an augmented library Θ(X) may be constructed, consisting of candidate nonlinear functions in each column. For example, Θ(X) may consist of constant, polynomial, and trigonometric functions.

$$Θ ( X ) = [ \begin{matrix}{{1}_{\vert}}^{\vert} & {{X}_{\vert}}^{\vert} & {{{X}^{{P}_{2}}}_{\vert}}^{\vert} & {{{X}^{{P}_{3}}}_{\vert}}^{\vert} & … & {{sin ( X )}_{\vert}}^{\vert} & {{cos ( X )}_{\vert}}^{\vert} & …\end{matrix} ] \qquad ( 3 )$$

Equation 4 provided below provides an example function for Θ(X).

$${X}^{{P}_{2}} = [ \begin{matrix}{x}_{1}^{2} ( {t}_{1} ) \\ {x}_{1}^{2} ( {t}_{2} ) \\ ⋮ \\ {x}_{1}^{2} ( {t}_{m} )\end{matrix} ] = [ \begin{matrix}{x}_{1}^{2} ( {t}_{1} ) & {x}_{1} ( {t}_{1} ) {x}_{2} ( {t}_{1} ) & ⋯ & {x}_{n}^{2} ( {t}_{1} ) \\ {x}_{1}^{2} ( {t}_{2} ) & {x}_{1} ( {t}_{2} ) {x}_{2} ( {t}_{2} ) & ⋯ & {x}_{n}^{2} ( {t}_{2} ) \\ ⋮ & ⋮ & ⋱ & ⋮ \\ {x}_{1}^{2} ( {t}_{m} ) & {x}_{1} ( {t}_{m} ) {x}_{2} ( {t}_{m} ) & ⋯ & {x}_{n}^{2} ( {t}_{m} )\end{matrix} ] \qquad ( 4 )$$

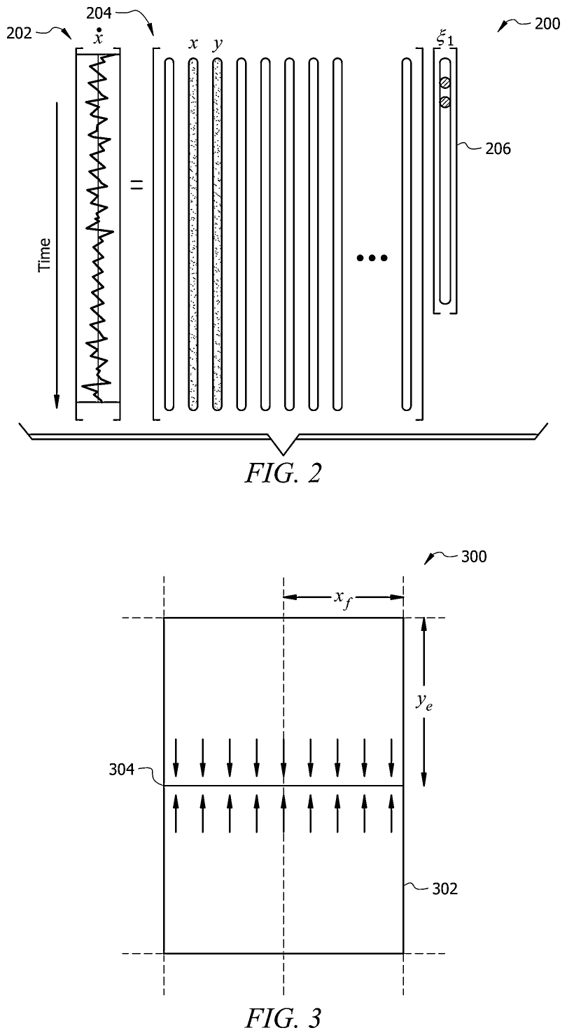

Each column of Θ(X) may be a candidate function for the right-hand side of Equation (1). According to the assumption of the sparsity of the governing physical equation, a sparse regression may be performed to determine the sparse vector of coefficients Ξ=[ξ₁, ξ₂, . . . , ξₙ]. In this context, the vector Ξ may be used to represent the coefficients that determine which terms in the regression library are active, as seen in FIG. 2. With these coefficients calculated, the governing equation of the physical system may be determined and a model may be used for future predictions. The present approach may focus on predicting an output quantity (i.e., rate normalized pressure) rather than its derivative, but the fundamental concept of SINDy may remain applicable.

FIG. 2 illustrates a schematic of an example framework 200 of using a sparse identification of nonlinear dynamics (SINDy) regression to identify dominant and relevant terms in a dynamical model, in accordance with certain embodiments. Framework 200 may be implemented to solve a sparse optimization problem in finding a sparse vector of coefficients Ξ 206 which optimally embeds a vector of derivatives \dot{x}(t) 202 of the state of a system with respect to time by recovering the dynamic model using the fewest terms in a regression library of the dynamical model as described in a matrix Θ(X) 204. Each column of matrix 204 represents a respective candidate nonlinear function with the respective column vector given by all possible time-series of d-th degree polynomials in the state x and state y of the system. For example, the regression library of the dynamical model may include a plurality of candidate nonlinear functions, such as one or more constant, polynomial, logarithmic, exponential, and trigonometric functions. The sparse vector of coefficients Ξ 206 may be used to determine which terms are active in the regression library, such as one or more candidate nonlinear functions. Once the sparse vector of coefficients Ξ 206 is computed, the framework 200 may be used to identify one or more governing equations in matrix 204 which are associated with one or more dominant and relevant terms in the dynamical model. Likewise, the discovered dynamical model may be used for future state prediction. However, the SINDy analysis may identify an inaccurate terms in the dynamical model when the plurality of candidate nonlinear functions in the regression library are non-orthogonal and/or overdetermined. In addition, the formulation described below is based on predicting an output quantity (e.g., rate normalized pressure) instead of its derivative, but the underlying concept of SINDy remains applicable.

Establishing the relationships between the rates and pressures of the fluid phases may uncover the fluid flow dynamics in MFHWs. An equation, of the form qₐ=f(BHP, t), in unconventional reservoirs may be determined, which is typically derived from diffusivity equations and represented by rate-normalized pressure expressions that are functions of reservoir properties, fluid PVT, well properties, and/or a time function dependent on the flow regimes. Here, a corresponds to oil, gas, and water phases for estimating the relationship for primary and secondary fluid phases. The reservoir and fracture properties (in case of hydraulically fractured wells) may be unknown, and estimating them using straight-line analysis based on knowledge about the characteristic equations may have been an objective in RTA. However, as previously stated, these approximations rely on several assumptions regarding the mechanics of fractures and reservoir geometries and require manual procedures that may lead to subjective interpretations. The present, data-driven approach using SINDy to obtain equations that express fluid flow at each well level may use commonly available data, such as rates and pressures. By analyzing the inherent information in the data concerning reservoirs and fractures, the primary characteristics that govern the system's behavior may be extracted. In light of these considerations, the approach may be centered on estimating rate normalized pressure (“RNP”) as a function of a set of time-dependent basis functions for primary phase rate (i.e., oil rate in case of an oil well) and then an expression for gas oil ratio (“GOR”) for an oil well that depends on time and BHP to subsequently estimate gas rates. These equations may be written as:

$$R N P = Θ ( t ) Ξ \qquad ( 5 )$$

$$G O R = Φ ( B H P , t ) Ξ \qquad ( 6 )$$

The approach may involve defining a collection of basis functions that vary with time (i.e., for RNP equation) and both time and BHP (i.e., for GOR equation), leveraging the understanding of fluid flow physics in hydraulic fractures. Using SINDy, a sparse system with significant characteristics that exert the greatest impact on the observed RNP and GOR data may be identified. Upon deriving the model and identifying the relevant coefficients, the quantities for any future time frame may be projected and/or estimated. With this estimate of RNP, the obtained equation may be used to simulate primary phase rate forecasts for any given BHP profile and similarly for GOR to simulate gas rates in a saturated oil well. Further, the present disclosed methods may be entirely automated, enabling identification of the relationship between rates and pressures by incorporating knowledge of fluid flow physics. This may eliminate the need to make prior assumptions about fractures and/or reservoirs.

The present disclosure provides for a selection of a feature library or set of basis functions guided by the principles of fluid flow in hydraulically fractured unconventional reservoirs. The feature library may then be incorporated into the aforementioned SINDy formulation, and an optimization routine may be utilized to determine the most appropriate features based on the current flow conditions and regimes. With respect to the present disclosure, the features required for the RNP formulation to be used for primary phase rate are described below followed by BHP and time-based features proposed for GOR estimation.

### Features for RNP Formulation

FIG. 3 illustrates an example vertical well with an infinite conductivity fracture extending to the boundary of the reservoir used for formulation of Wattenbarger's constant rate and constant pressure equations. For example, solutions have been utilized (i.e., Wattenbarger's Type Curves) for constant rate and constant pressure inner boundary conditions for liquids for a vertical well with a closed boundary. Although unconventional reservoirs may not always exhibit transient linear flow and boundary-dominated flow due to the interplay of different reservoir properties and fracture geometries, these solutions may serve as a valuable reference point. As shown, a conceptual model 300 of a vertical well with an infinite conductivity fracture 304 may extend to the boundary of a closed reservoir 302, in accordance with certain embodiments. In some embodiments, extended periods of linear flow may be observed in many unconventional reservoirs, such as a gas reservoir with hydraulic fractures designed to extend to the drainage boundary of the well. The fracture 304 is assumed to be extended to the boundaries of the reservoir 302. Using solutions for constant rate (CR) and constant pressure (CP) inner boundary conditions for liquids, assuming the geometry (closed boundary) shown in FIG. 3, for a vertical well with a closed boundary, a transient linear flow and a boundary-dominated flow may be significant flow regimes in unconventional reservoirs. While the transient linear flow and the boundary-dominated flow are not always observed for unconventional reservoirs, because of various combinations of reservoir properties and fracture geometries, the solutions for the conceptual model 300 may serve as a useful reference point. The Wattenbarger constant rate solution may be expressed as follows:

$${p}_{wD} = \frac{π}{2} ( \frac{{y}_{e}}{{x}_{f}} ) [ \frac{1}{3} + {( \frac{{x}_{f}}{{y}_{e}} )}^{2} {t}_{Dxf} ] - \frac{2}{{π}^{2}} ( \frac{{y}_{e}}{{x}_{f}} ) {\sum }_{n = 1}^{∞} ( \frac{1}{{n}^{2}} ) exp ( - {n}^{2} {{π}^{2} ( \frac{{x}_{f}}{{y}_{e}} )}^{2} {t}_{Dxf} ) \qquad ( 7 )$$

$${p}_{wD} = \frac{kh ( {p}_{i} - {p}_{wf} )}{14 1.2 qB μ} \qquad ( 8 )$$

$${t}_{Dxf} = \frac{0.00 \; 633 kt}{ϕ μ {c}_{t} {x}_{f}^{2}} \qquad ( 9 )$$

With reference to FIG. 3, boundary-dominated flow may follow transient linear flow. In certain embodiments, the element of symmetry may come into play for online production of MFHWs with equal fracture spacing and length, where the reservoir beyond the fracture tips may not significantly contribute to flow. Under this circumstance, an initial phase of transient linear flow towards the fractures, followed by the depletion of the inter-fracture volume, may be observed. The solutions provided by Equation (5) may offer short-term approximations. These approximations may correspond to the solutions for an infinite reservoir outer boundary. The following equations represent the approximations for constant rate.

$${p}_{wD} = \sqrt{π {t}_{Dxf}} \qquad ( 10 )$$

Closed reservoir solutions may be approximated by the following equations for longer times:

$${p}_{wD} = \frac{π}{2} ( \frac{{x}_{f}}{{y}_{e}} ) {t}_{Dxf} + \frac{π}{6} ( \frac{{y}_{e}}{{x}_{f}} ) \qquad ( 11 )$$

Similar equations may be represented for single phase gas flow using pseudo pressures to account for variable PVT properties with pressures in gas. p_{wD} may be replaced with m_{wD} in Equation (12) below.

$${m}_{wD} = \frac{kh [ m ( {p}_{i} ) - m ( {p}_{wf} ) ]}{1424 {q}_{g} T} \qquad ( 12 )$$

$$m ( p ) = 2 {\int }_{{p}_{0}}^{p} \frac{p}{z μ} dp \qquad ( 13 )$$

In a closed linear reservoir with fractures extending to the reservoir boundaries and single-phase flow, a feature library to represent RNP may be prompted. Based on the previously stated equations, a linear combination of the following features may be adequate to describe fluid flow expressions in such a reservoir and fracture system. Table 1 below shows the features based on Wattenbarger's equation.

TABLE 1

| Features | Description |
|---|---|
| 1 | Constant |
| t | Major contribution at long time BDF |
| exp(−αt) | For multiple α ∈ R |
| | (early transient linear flow), typically in range |
| | [10⁻³, 10⁻¹] |
| | based on the terms used to define α |

All other parameters in the expression may be constant and may correspond to reservoir, fracture, and fluid properties. Using the suggested SINDy formulation, the coefficients related to each feature may represent a lumped quantity that corresponds to the coefficients in the original equation. In a later section, an example case study may be presented demonstrating how SINDy may accurately retrieve the original equation while preserving information about fracture and reservoir properties.

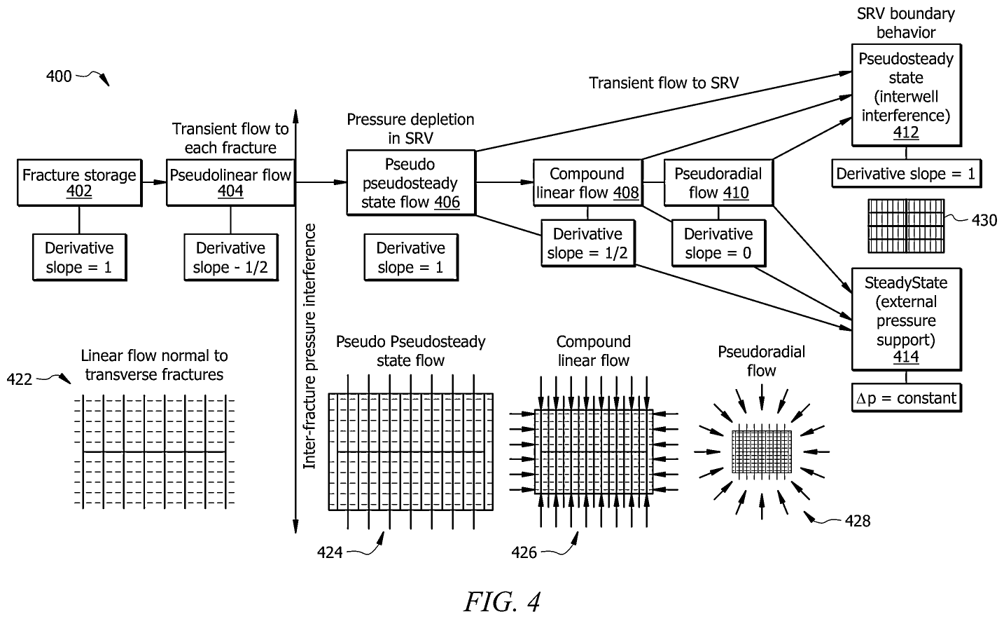

FIG. 4 illustrates example potential flow regimes in multi-fractured horizontal wells. In embodiments, a crucial step in the RTA workflow may be identifying flow patterns during flowback and early production, as they may determine the appropriate models for estimating reservoir and fracture properties and conducting type curve analysis. Unconventional reservoirs with MFHWs may comprise unique flow characteristics and patterns, both within the reservoir and towards the hydraulic fractures, throughout a well's production life. Various references may describe the typical sequence of flow patterns for long-term production in MFHWs. The systems and methods of the present disclosure may apply the SINDy formulation to forecast production, and provide the production phase after flowback.

FIG. 4 provides an example progression 400 of potential flow regimes in a multi-fractured horizontal well (MFHW), in accordance with certain embodiments. An expected progression 400 of flow regimes in a MFHW may include a fracture storage regime 402, a pseudoinear flow regime 404, a pseudo pseudosteady state flow regime 406, a compound linear flow regime 408, a pseudoradial flow regime 410, a pseudosteady state regime 412, a dual permeability or porosity regime, and a steady state regime 414. For example, in a diagnostic fracture injection test (DFIT), a relatively small volume of fluid is injected into the subsurface, creating a hydraulic fracture. After the end of injection, the pressure in the wellbore is monitored for hours or days. The pressure measurements are used to infer a plurality of key parameters for properties of the formation, such as leakoff coefficient, permeability, fracture closure pressure, and formation pressure, etc., for hydraulic fracture design and reservoir engineering.

In some embodiments, a fracture may not form at early times and the pressure behavior may be dominated by a fracture storage regime 402. The fracture storage regime 402 may be indicated by a unit-slope straight line with a 1.0 derivative slope on a log-log plot in which pressure changes linearly with time. The fracture storage regime 402 is associated with a wellbore storage effect immediately after a production start-up or shut-in. In some embodiments, the wellbore storage effect may be dominated by the compressibility and the volume of a fracturing fluid. For example, the compressibility is high for a gas-filled wellbore, and the wellbore storage effect may occur over a longer period of time. As another example, the compressibility is much lower for a liquid-filled wellbore, and the wellbore storage effect may dissipate more quickly. As another example, typically in oil wells, both gas and liquid are present within the wellbore and the liquid level changes after shut-in. Thus, fracture storage regime 402 may be affected by a changing liquid level as well as compressibility the liquid. In some embodiments, when a shut-in period following a fracture injection only extends to the end or slightly beyond closure, the equivalent constant rate pressure and derivative data may remain fracture storage dominated flow regime 402 during the entire pressure falloff.

In some embodiments, the pressure behavior at early times may be dominated by a pseudolinear flow regime 404 at early times after closure when sufficient fracture half-length is created during the injection, provided the fracture after closure has essentially infinite conductivity. The pseudolinear flow regime 404 may include a linear flow 422 which shows the fracturing fluid flows to each fracture in a direction normal to the transverse fractures. The pseudolinear flow regime 404 is indicated by a 0.5 derivative slope on the log-log plot of RNP derivative versus time. In some embodiments, the pressure behavior may be dominated by a pseudo pseudosteady state flow regime 406 at middle times when inter-fracture interference increases with extended fractures, resulting in different fracture extension pressures and widths. A pseudo pseudosteady state flow 424 shows the fracturing fluid is filtered into the reservoir matrix after fracturing, reducing formation stress. The pseudo pseudosteady state flow regime 406 is indicated by an about 1.0 derivative slope on the log-log plot of RNP derivative versus time.

In some embodiments, the pressure behavior may be dominated by a compound linear flow regime 408 at middle times when the fractures fluid flows to SRV. The compound linear flow 426 during this period is perpendicular to the primary linear flow. The compound linear flow regime 408 is indicated by an about 0.5 derivative slope on the log-log plot of RNP derivative versus time. In some embodiments, the pressure behavior may be dominated by a pseudoradial regime 410 at later times. If the fracture half-length is not very long, the pseudoradial flow 428 may appear during the extended test. Its pressure derivative may approach as a horizontal straight line at later times indicated by a 0.0 derivative slope on the log-log plot of RNP derivative versus time.

In some embodiments, the pressure behavior may be dominated by a pseudosteady state regime 412 at late times when the outer boundaries of the reservoir are all no flow boundaries. For example, the pseudosteady state regime 412 may occur when the reservoir boundaries are sealing faults. As another example, the pseudosteady state regime 412 may occur when nearby producing wells cause no flow boundaries to arise. The pseudosteady state flow 430 shows the reservoir behaves as a tank. The pressure throughout the reservoir decreases at the same, constant rate. In some embodiments, the pressure behavior may be dominated by a steady state regime 414 at late times when there is no change anywhere with time.

In embodiments, the flow patterns during this phase may be determined to identify the relevant features for the feature library. The initial flow pattern theoretically following flowback may be referred to as bilinear flow. This pattern may arise when the dimensionless fracture conductivity is less than 50, resulting in intra-fracture transient linear flow and formation transient linear flow that combine to create the bilinear flow regime. When viewed on a log-log plot of RNP versus time or log-log derivative plot for a constant rate, the bilinear flow regime may be identified by a quarter slope (i.e., 0.25). The characteristic plot of RNP vs t^{0.25} may show a linear fit slope, which may be used to estimate fracture conductivity, provided that the matrix permeability is known.

The analysis of linear flow maybe one of the most frequently performed flow regime analyses because it occurs during the initial stages of production and may allow for an estimation of the \sqrt{k}X_{f}. In certain wells, the linear flow regime may persist for several years, depending on reservoir parameters and fracture geometries. For oil wells with constant rate, the linear flow equation to the fractures may be written in dimensionless form as:

$$\frac{{p}_{i} - {p}_{wf}}{{q}_{sc}} = \frac{4.06 B}{h} \sqrt{\frac{μ t}{ϕ {c}_{t} k {X}_{f}^{2}}} \qquad ( 14 )$$

A comparable equation may be developed for gas wells utilizing pseudo pressures. On a square root plot of RNP versus \sqrt{t}, this relationship may exhibit a linear trend. The slope of this line may be used to estimate the \sqrt{k}X_{f} product.

The stimulated rock volume (“SRV”) flow regime may be the next common flow pattern that may be examined and evaluated. It may display similar characteristics to the traditional pseudo-steady-state (“PSS”) flow regime. However, the PSS flow regime may only pertain to the SRV rather than the entire reservoir volume. The SRV may be the maximum practical volume from which fluid can be produced, and any flow beyond this volume may be minor and may take years to decades to become evident. The SRV flow regime may be identified by a unit slope on a log-log plot of RNP versus time or log-log derivative plot.

By employing conventional PSS concepts, a linear analysis on this segment of the data may be performed, which allows for estimation of a “drainage area,” or the SRV. In the case of oil wells, the slope of the straight line on a plot of RNP versus material balance time may be expressed as:

$$m = 0.234 \frac{B}{ϕ {c}_{t} h A} \qquad ( 15 )$$

Similarly, for gas the slope may be given by:

$$m = 2348 \frac{T {P}_{sc}}{ϕ {c}_{ti} h {μ}_{gi} A {T}_{sc}} \qquad ( 16 )$$

In the later stages of well production, after fracture interference and possibly a period of between-fracture depletion, there may be a second period of formation transient linear flow. This may be referred to as compound linear flow or late linear flow. Analysis of compound linear flow provides L_{w}\sqrt{k}, where L_{w} may be effective producing well half-length, or the half-length of the well that may be efficiently stimulated (i.e., in contact with the reservoir). The application of the constant rate solution to the linear flow plot yields L_{w}\sqrt{k}. Single-phase flow of undersaturated oil during compound linear may be determined as follows:

$${L}_{w} \sqrt{k} = \frac{4.064 {μ}_{oi} {B}_{oi}}{{m}_{{LFP}_{CR}} h} {( \frac{1}{ϕ {μ}_{0} {c}_{t}} )}_{i}^{0.5} \qquad ( 17 )$$

In theory, a sufficiently long period of time passed, the system may transition to the more conventional Infinite Acting Radial Flow (“IARF”) regime. In unconventional reservoirs, this may take hundreds to thousands of years of production. However, this may be improbable to happen because, by that time, the production would have significantly declined, and the well would have been long abandoned. Therefore, the IARF flow regime may not be considered as a potential feature. Considering the commonly analyzed flow regimes in MFHWs discussed above, a list of features may be complied as potential candidates for the feature library. Several of these features were previously discussed as components of Wattenbarger's equation.

TABLE 2

| Features based on typical | |
|---|---|
| flow regime analysis | Flow Regimes |
| t^{0.25} | Bilinear flow |
| t^{0.5} | Linear flow to |
| | individual fractures |
| t | SRV flow/Pseudo |
| | steady state flow |
| t^{0.5} | Compound linear flow |

In embodiments, additional features may be proposed that can be linked to more complex flow regimes that are difficult to capture using traditional straight-line analysis or do not exhibit the anticipated behavior. The actual fracture growth and distribution within a well may be complex, making it difficult to model using analytical formulations.

Transitional flow regimes (i.e., radial/elliptical) may be observed during inter-fracture flow. After an initial period of production where flow to each fracture may be independent, pressure distributions around the fractures may start to interfere, causing both the normalized pressure and pressure derivative to slightly deviate upwards from the expected linear flow half-slope trend. This may signify a reduction in well productivity. This transitional flow period may be represented by a nonlinear trend with continuously changing slope until there may be a transition to SRV flow.

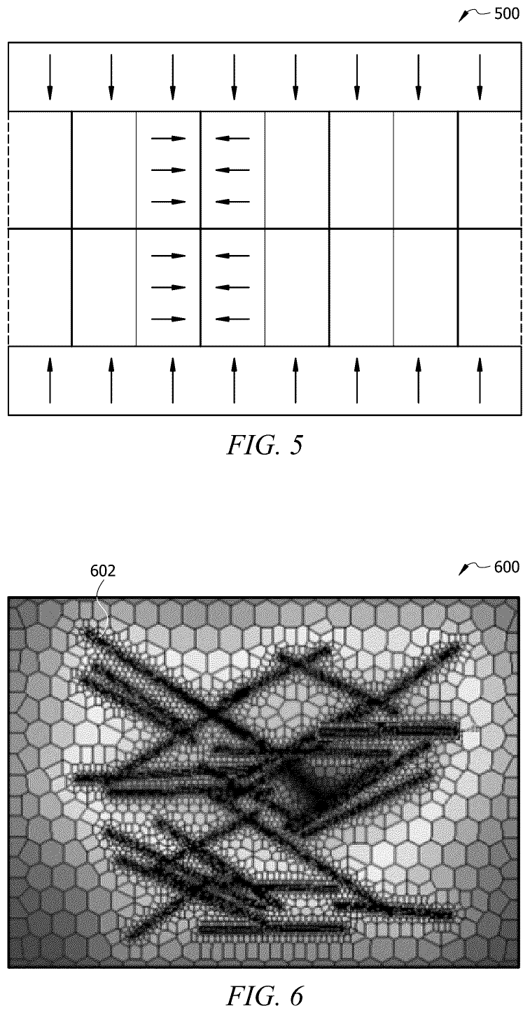

In certain embodiments of shale reservoirs with very low permeability, a depletion signature may be determined, which is characterized by unit slope on the log-log RNP/RNP′ plot. FIG. 5 illustrates a schematic of a conceptual model 500 of a simultaneous inter-fracture flow and boundary dominated flow, in accordance with certain embodiments. In very low-permeability (shale) reservoirs, a pure depletion signature may be observed (unit slope on log-log RNP/RNP′ plot). The pure depletion signature may be attributed to lack of inflow of reservoir fluid from outside of the stimulated region to inter-fracture region, as depicted in FIG. 5. As illustrated, there may be no inflow of reservoir fluid from outside the stimulated region to the inter-fracture region. Furthermore, many flow regimes may coexist in a complex fracture system, which is frequently the result of reservoir heterogeneity and completion efficiency. When numerous flow regimes coexist, the diagnostic plots may not show a clear signature of a specific flow regime.

In embodiments wherein fractures in wells have uneven spacing and different lengths, or when the fracture geometry may be complex, such as the complex facture network 600 in FIG. 6, there may be no linear flow pattern observed. The complex fracture network 600 may include a plurality of fractures 602 with a complex fracture geometry. For example, the fractures 602 are not spaced uniformly and have unequal lengths, etc. A linear flow regime is not sufficient to characterize the dynamical flow associated with the complex fracture network 600. As a result, the pressure and flow rate behaviors observed in unconventional reservoirs that do not exhibit linear flow regime may be interpreted. To address this issue, a technique may be introduced that enables the interpretation of pressure and flow rate behavior in unconventional wells that don't have a linear flow regime. This method may provide a means to identify various flow regimes, such as sub-linear, linear, and sub-radial, on a standard loglog plot. A multi-fractured horizontal well in a fractured formation may be compared to a fractured well (with the fracture length equal to the sum to all initially connected high conductivity fractures) that drains a reservoir with a flowing area A, that may be perpendicular to the flow and changes with distance according to the power law:

$$A = {X}_{f} {hr}_{D}^{2 δ - 1} \qquad ( 18 )$$

where: X_{f} may be the half flow area width, r_{D}=r/r*, r may be the distance and r* may be taken as the half fracture length, and δ may be the half flow dimension.

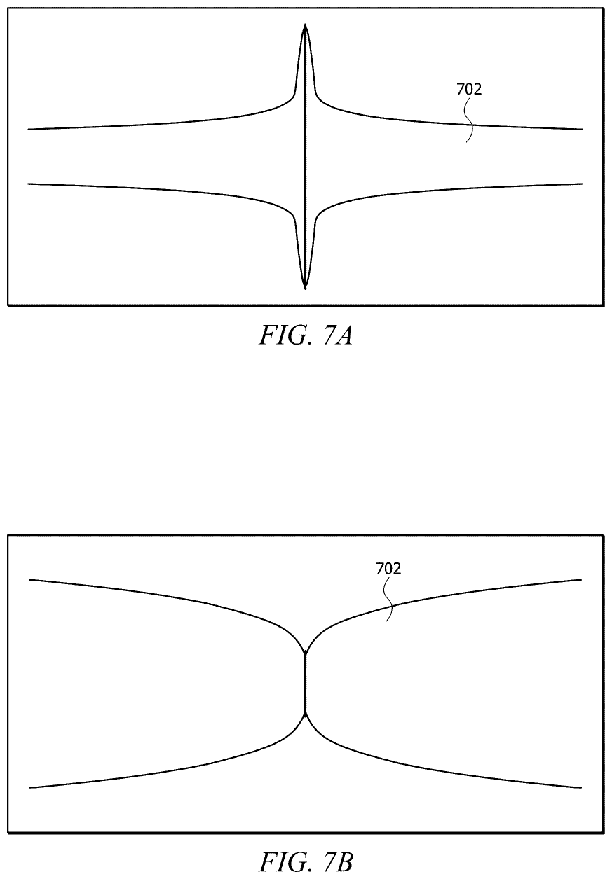

When δ=0.5, the flow pattern may be linear, and the flowing area may remain constant concerning the distance to the fracture area, which means the scenario becomes equivalent to the channel geometry. Additionally, δ=1 may correspond to the classical radial flow, while δ=0 represents the pseudo steady-state. This generalized model includes the cases with flow area 702 decreasing with the distance from the fracture (sub-linear flow, values of 0<δ<0.5, as shown in FIG. 7A), and flow area 702 increasing with the distance from the fracture (sub-radial flow, values of 0.5<δ<1, as shown in FIG. 7B).

In such intricate flow patterns, the pressure and its derivative may be dependent on time raised to the power of (1-δ), which may be determined through a log-log plot. The sub-linear case may indicate a multi-fractured horizontal well in a densely fractured reservoir, where the areas drained by each fracture may decrease as a result of fractures interfering with each other. Conversely, the sub-radial case may correspond to a network of fractures with varying conductivity, where low conductivity fractures may have a more pronounced increase in drainage area concerning the distance from the fracture.

TABLE 3

| Features based on complex | |
|---|---|
| fractures | Interpretation |
| t^{1-δ} | δ ∈ (0, 0.5) for sublinear flow |
| | δ ∈ (0.5, 1) for subradial flow |

All possibilities of feature space that could represent the relationship between flow rates and pressures for various reservoir and fracture flow mechanisms and configurations may be determined. To accomplish this, an optimization algorithm may be utilized to identify the most suitable combination of features that accurately describes the data at the well level. Since each well has unique characteristics that impact fluid flow, such as well completion efficiency, spacing, timing, and reservoir properties, no mechanistic assumptions may be made regarding fractures and reservoirs. Instead, the characteristics of the relationships may be determined based on the data. Based on the descriptions about various flow regimes, as discussed above, the relationship to be characterized using the hybrid SINDy approach may be shown below to find sparse combinations of aᵢ and bⱼ coefficients that explain the relationship.

$$P N R = {\sum }_{i} {a}_{i} {t}^{m} + {\sum }_{j} {b}_{j} {e}^{- n t} , \\ where typically m ∈ [ 0 , 1 ] and n ∈ [ 1 {0}^{- 3} , {10}^{- 1} ] \qquad ( 19 )$$

### Features for GOR

In unconventional reservoirs, GOR behavior may be driven by bottom-hole pressure or “BHP” schedule, the degree of undersaturation, fracture parameters, gas-oil PVT properties, relative permeabilities, bubble point suppression effects, and duration of the transient-flow regime. However, BHP may be a predominant factor of GOR behavior in unconventional MFHWs as the GOR behavior progresses through several stages. In embodiments, changing operating conditions and/or bottom-hole pressures and PVT properties may be necessary to consider when determining GOR behavior in unconventional reservoirs. Table 4 below provides three features based on field behavior and empirical observations that may account for these limitations and may avoid predetermining a functional form to express GOR behavior by allowing data to drive the appropriate choice of functions.

TABLE 4
Pressure and Time Features
softplus (a * t − b)
softplus (a * BHP − b)
$sigmoid ( a * \frac{t}{B H P} - b )$

The softplus and sigmoid basis functions may be chosen to handle the different stages in typical GOR history of unconventional wells and an onset of various phenomena—namely, constant GOR above saturation pressure, evolution of gas from solution as the fluid pressure falls below saturation pressure, transient GOR plateau, steady increase with boundary dominated flow, and/or depletion. Here, various values of a and b may be proposed for candidate features in the feature library. Variable a may dictate the rate of change in the function with higher values corresponding to faster rate, while variable b corresponds to translation, which may determine the rise in GOR at a future time. Thus, the final GOR formulation may not necessarily be restricted to a fixed functional form but can be a combination of various functionals depending on the complexity and dynamics associated with a well.

Further below, several case studies are presented as examples using the proposed SINDy workflow to identify flow equations in single-phase and multi-phase MFHWs under different reservoir geometries and fracture configurations. The flow equations discovered through this process are subsequently applied to forecast production for a specific bottomhole pressure profile in the following Examples 1-7.

### Example 1—Constant Oil Rate—Wattenbarger Model

The first example involved utilizing Wattenbarger's closed reservoir boundary, represented in Equation (7), to model fractures extending to the boundary of a single-phase oil reservoir. Table 5 below presents the input parameters applied to simulate the model and generate a bottomhole pressure profile for a constant rate input.

TABLE 5

| pᵢ | 5000 | psi |
|---|---|---|
| q | 100 | STB/d |
| B | 1.2 | bbl/STB |
| μ | 0.3 | |
| yₑ | 500 | ft |
| x_{f} | 500 | ft |
| ϕ | 0.1 | |
| cₜ | 7.8 * 10⁻⁶ | psi⁻¹ |
| k | 0.001 | mD |
| h | 100 | ft |

| | |
|---|---|
| num fracs | 10 |

Using element of symmetry, the outcomes displayed in the following figures are for a single fracture and are comparable to the illustration provided by Wattenbarger. The SINDy formulation predicts rate normalized pressure (“RNP”) for the proposed time-dependent features listed in Table 1. The study proposes 52 potential features, the first 50 of which represent exponential terms that primarily correspond to initial transient flow conditions taken at uniformly sampled coefficients (a in Table 1) between 0.001 and 0.1 on a log scale. The 51st feature may be a constant, while the 52nd feature corresponds to a linear time feature that dominates during boundary-dominated flow. To generate multiple datasets, the model was executed for various durations (1000 days, 5000 days, and 10000 days). For each scenario, 75% of the data may be employed to train the model, and the remaining 25% may be used to validate it.

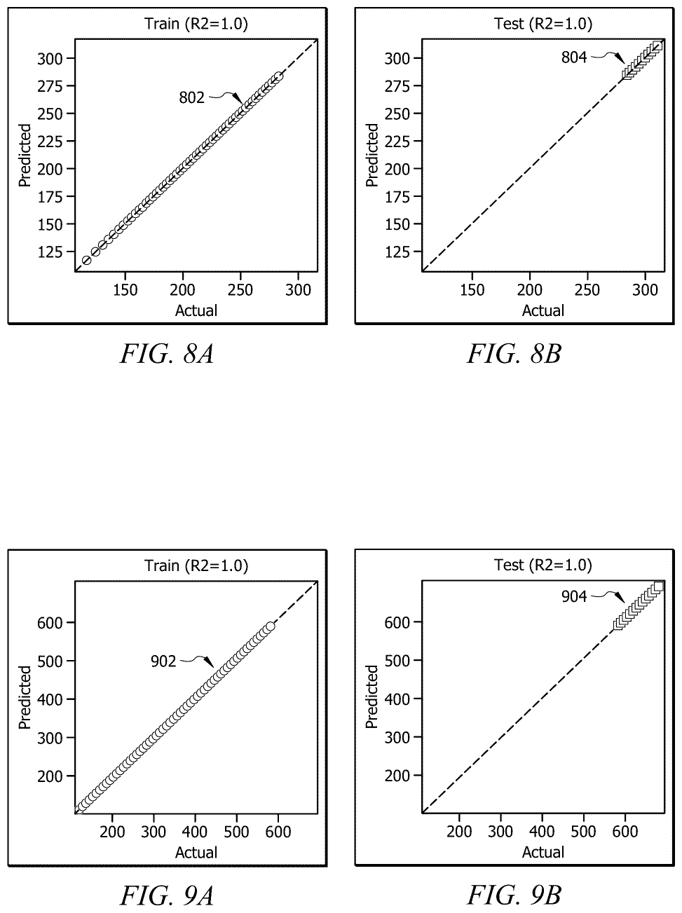

The plots illustrated in FIGS. 8A-9B depict the RNP cross plot for the true and predicted values of the models, for both train and test sets, after running for 1000 and 5000 days. The plots show that the model may be capable of precisely predicting the RNP estimates. Thus, for any operational scenario and the bottom-hole pressure profile, the model may provide accurate predictions for the oil rate estimates.

FIGS. 8A and 8B illustrate plots of predicted vs. actual rate normalized pressure (RNP) data for a machine learning training portion and a test portion, respectively, taken from a 1,000 day dataset, in accordance with certain embodiments. The hybrid SNR method may be used to train the first model in order to predict RNP estimates by identifying one or more relevant terms from the 52 candidate features in the candidate feature library. FIG. 8A shows a good consistency 802 with a R-squared (R2) value of 1.0 in a cross plot of the predict RNP values and the actual RNP data in the machine learning training portion. FIG. 8B shows a good consistency 804 with an R2 value of 1.0 in a cross plot of the predict RNP values and the actual RNP data in the test portion. The consistency between the predict RNP values and the actual RNP data in the machine learning training portion and the test portion indicates that the first model is accurate to predict the RNP estimates. Likewise, for any operational scenario with a bottomhole pressure profile, the first model may be used to accurately predict oil rate estimates. An R2 value shows how well the model predicts the outcome of the dependent variable. An R2 value of 0 means that the model explains or predicts 0% of the relationship between the dependent and independent variables. An R2 value of 1.0 means that the model explains or predicts 100% of the relationship between the dependent and independent variables.

FIGS. 9A and 9B illustrate plots of predicted vs. actual RNP data for a machine learning training portion and a test portion, respectively, taken from a 5,000 day dataset, in accordance with certain embodiments. The proposed hybrid SNR method may be used to train the first model to predict RNP estimates by identifying one or more relevant terms from the 52 candidate features in the candidate feature library. FIG. 9A shows a good consistency 902 with an R2 value of 1.0 in a cross plot of the predict RNP values and the actual RNP data in the machine learning training portion. FIG. 9B shows a good consistency 904 with an R2 value of 1.0 in a cross plot of the predict RNP values and the actual RNP data in the test portion. The consistency between the predict RNP values and the actual RNP data in the machine learning training portion and the test portion indicates that the first model is accurate to predict the RNP estimates. Likewise, for any operational scenario with a bottomhole pressure profile, the first model may be used to accurately predict oil rate estimates.

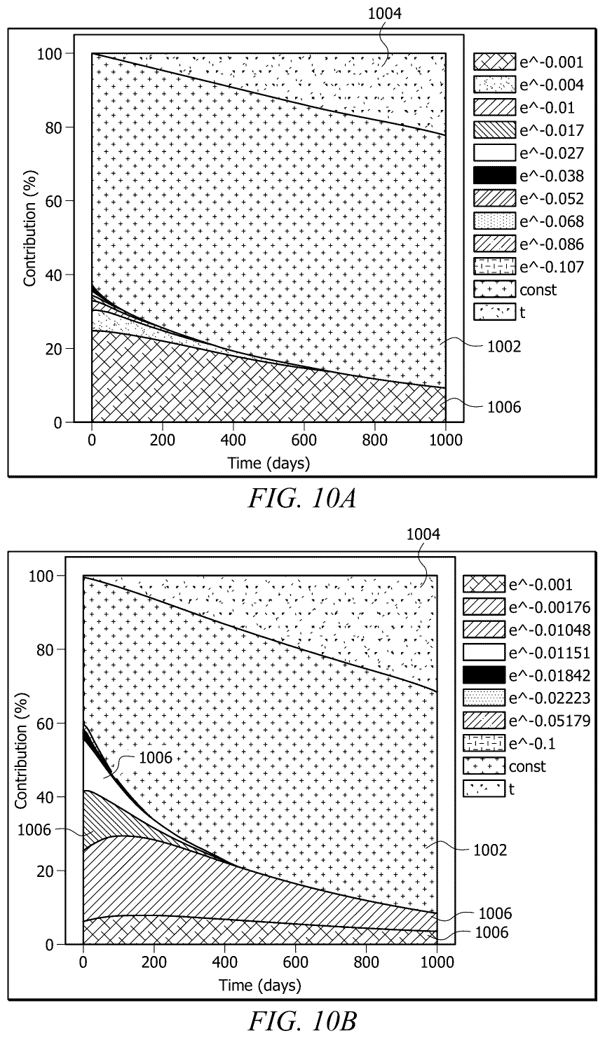

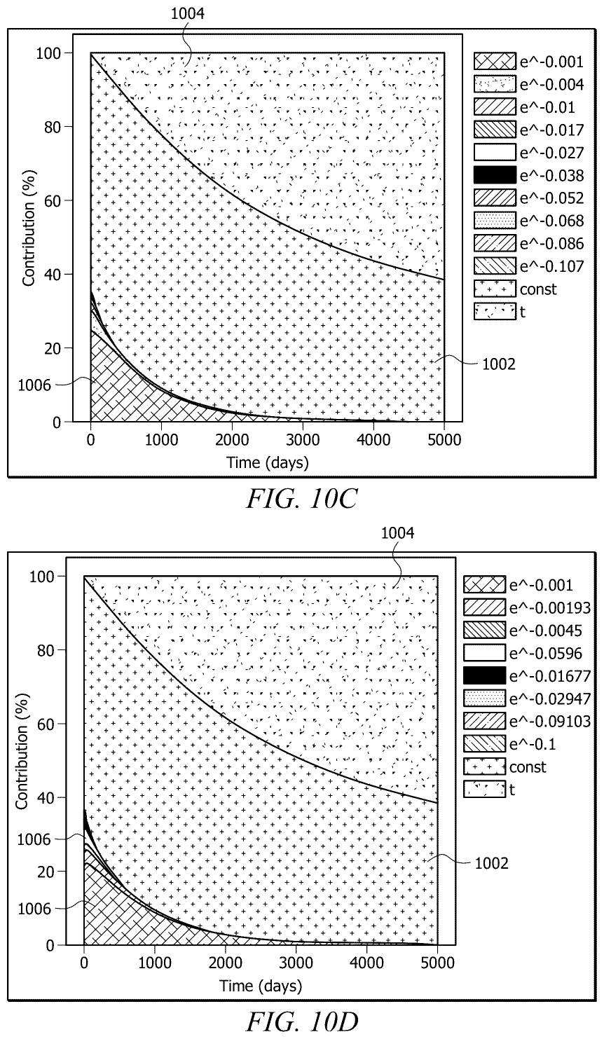

In addition to the forecast estimates, the proposed approach may promote sparsity on the set of potential features by selecting the pertinent ones. Coefficients of the selected basis functions that accurately represent the actual underlying equation may be determined as well. FIGS. 10A-10D illustrate the selected features (out of a total of 52 in this case) and their contributions with time for both the truth case and the SNR model predicted scenarios.

FIGS. 10A-10D illustrate plots showing importance of various coefficients with time for actual data for a 1,000 day dataset (FIG. 10A), predicted data for a 1,000 day dataset (FIG. 10B), actual data for a 5,000 day dataset (FIG. 10C), and predicted data for a 5,000 day dataset (FIG. 10D), in accordance with certain embodiments. In some embodiments, the hybrid SNR method may be used to induce sparsity on the candidate feature library and determine one or more coefficients associated with one or more relevant features from the candidate feature library. Furthermore, the proposed hybrid SNR method may determine if the one or more coefficients corresponding to the selected basis functions closely represent the true underlying equation.

FIGS. 10A and 10B show the selected features (out of a total of 52 in this case) and their contributions with time for both the truth case and the model predicted scenarios for the 1,000 day dataset. The first model has successfully eliminated several candidate basis functions and identified ten features to achieve an accurate match to the actual data. The ten features include a constant feature 1002, a linear time feature 1004, and eight exponential features 1006. The exponential features 1006 are the short transients that may not be of primary interest. Further, since exact a values for the exponential features may not be proposed (due to the unknown values of parameters contributing to a), the coefficients of these exponential features 1006 predicted by the optimization algorithm should be such that the linear combination of these features selected will closely represent the actual features. However, the coefficients of the constant feature 1002 and the coefficients of the linear time feature 1004 may be directly correlated in FIG. 10A and FIG. 10B since those are the exact features used as in the actual analytical equation.

FIGS. 10C and 10D show the selected features (out of a total of 52 in this case) and their contributions with time for both the truth case and the model predicted scenarios for the 5,000 day dataset. The first model has successfully eliminated several candidate basis functions and identified ten features to achieve an accurate match. The ten features include a constant feature 1002, a linear time feature 1004, and eight exponential features 1006. The exponential features 1006 are the short transients that may not be of primary interest. Further, since exact a values for the exponential features may not be proposed (due to the unknown values of parameters contributing to a), the coefficients of these exponential features 1006 predicted by the optimization algorithm should be such that the linear combination of these features selected will closely represent the actual features. However, the coefficients of the constant feature 1002 and the coefficients of the linear time feature 1404 may be directly correlated in FIG. 10C and FIG. 10D since those are the exact features used as in the actual analytical equation.

The SNR model may have eliminated various potential basis functions and produced ten features that yield an accurate match. The exponential terms may be among these features, which are short transients and may negligible significance. Because the exact values of a for the exponential features may not be proposed (due to the unknown values of parameters contributing to α), the coefficients of these exponential features predicted by the optimization algorithm may be such that the linear combination of these features selected will closely represent the actual features. However, the coefficients of the constant and the linear time features may be directly correlated since those are the exact features used in the actual analytical equation. From Equation (7), by re-writing the equation with respect to RNP and time, the coefficients associated with the constant and linear time terms may be represented as follows:

$${c}_{const} = 70.6 * \frac{π}{3} * \frac{B μ}{kh} * ( \frac{{y}_{e}}{{x}_{f}} ) \qquad ( 20 )$$

$${c}_{lin \_ time} = 70.6 * π * \frac{B μ}{k h} * ( \frac{{y}_{e}}{{x}_{f}} ) * ( \frac{0.00633 k}{{( ϕ μ {c}_{t} )}_{i} {y}_{e}^{2}} ) \qquad ( 21 )$$

Table 6 below displays a comparison between the coefficients of constant and linear time features for datasets consisting of 1000, 5000, and 10000 days. The datasets were generated and trained on 75% of the total data for each case. The results reveal that the coefficients closely match the true values, particularly when the train dataset may be longer. The constant and linear term coefficients with 750 days of training data, where the transient flow may be still predominant, show relatively higher error. However, with more training data (i.e. 3750 and 7500 days), the error decreases and the coefficients become almost identical. The reason for the higher error in the constant and linear term coefficients with only 750 days of training data may be due to limited availability of the data that restricts understanding of complete physical behavior of fluid flow. However, the physics related to short-term predictions, where the transient flow behavior may be dominant, is well-captured. This may enable an extremely precise forecast for the next 250 days of test data, as demonstrated in FIGS. 8A and 8B.

TABLE 6

| | | Predicted | Predicted | Predicted |
|---|---|---|---|---|
| | | Coefficients | Coefficients | Coefficients |
| | | (Train - | (Train - | (Train - |
| | Actual | 750 | 3,750 | 7,500 |
| Features | Coefficients | days) | days) | days) |
| Constant | 266.15 | 214.2 | 267.3 | 266.38 |
| Linear | 0.086 | 0.107 | 0.086 | 0.086 |
| Time | | | | |

### Example 2—Closed Boundary with Unevenly Spaced Fractures

The second example involved generating several scenarios with various reservoir and fracture configurations. In this instance, features other than those derived from Wattenbarger's equation, such as those outlined in Table 2 and Table 3 to represent common flow regime diagnostics along with other complex flow conditions, may be included. In the present embodiment, a complex case of fractures that are not uniformly spaced in a closed boundary reservoir was examined. This embodiment simulated a complex completion, where various fractures were not initiated due to reservoir heterogeneities, operational difficulties, or incorrect design decisions. As discussed above, a unique linear transient flow pattern may not be detectable, and as a result, conventional line-fitting methods and characteristic equations was not utilized.

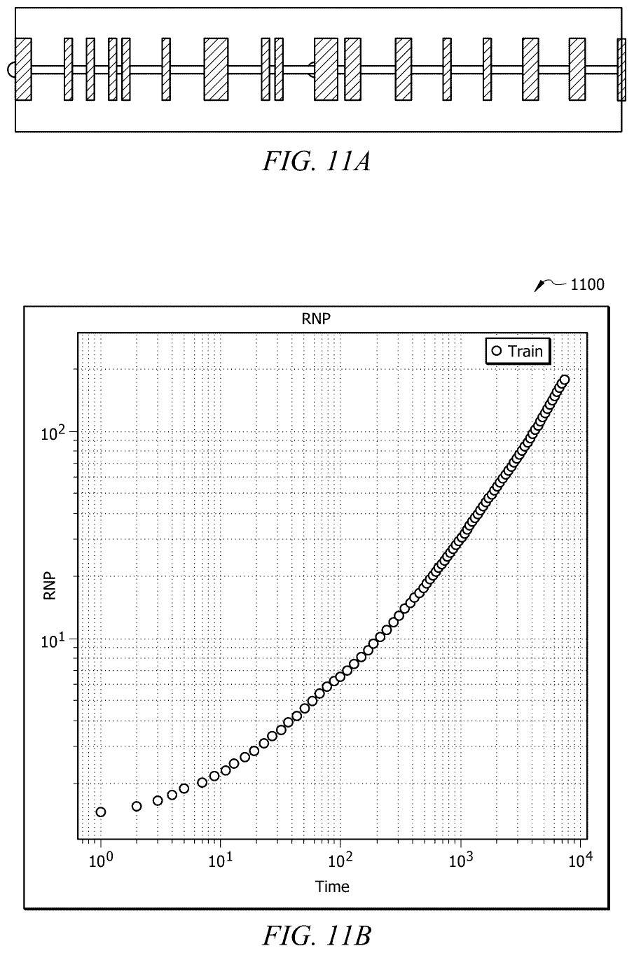

FIG. 11A illustrates the fracture and reservoir geometry case simulated here for a duration of 20 years to generate the BHP profile for a variable rate constraint, and the corresponding RNP profile may be shown in plot 1100 in FIG. 11B. The fractal model used had a half flow dimension (δ) of 0.3, indicating sub-linear flow due to a decrease in the flowing area away from the fracture at a cumulative well level compared to evenly spaced fractures.

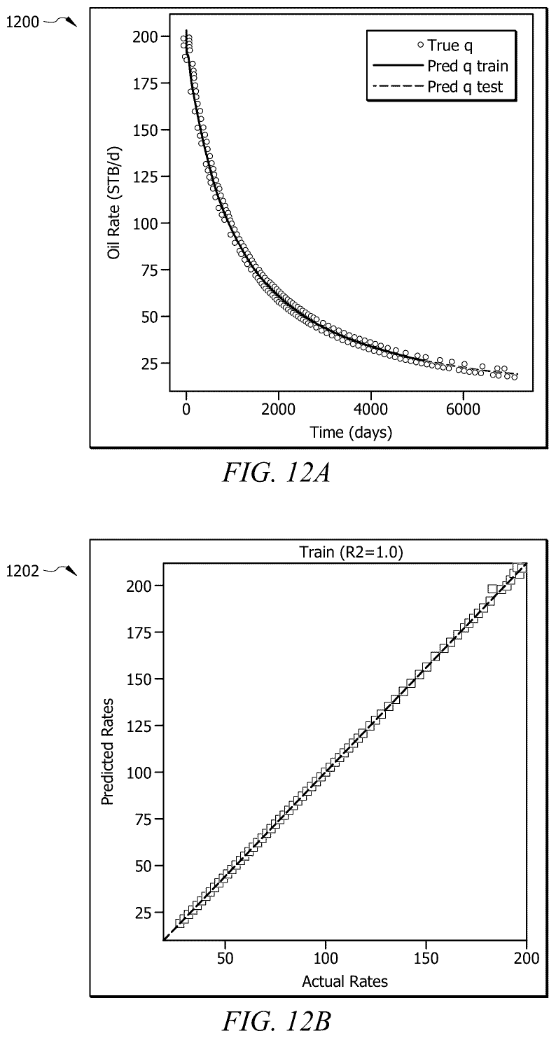

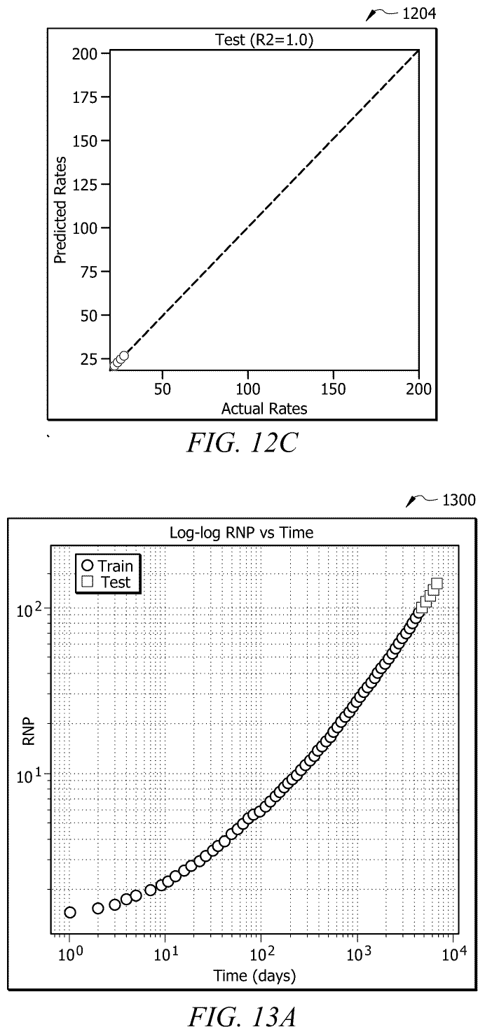

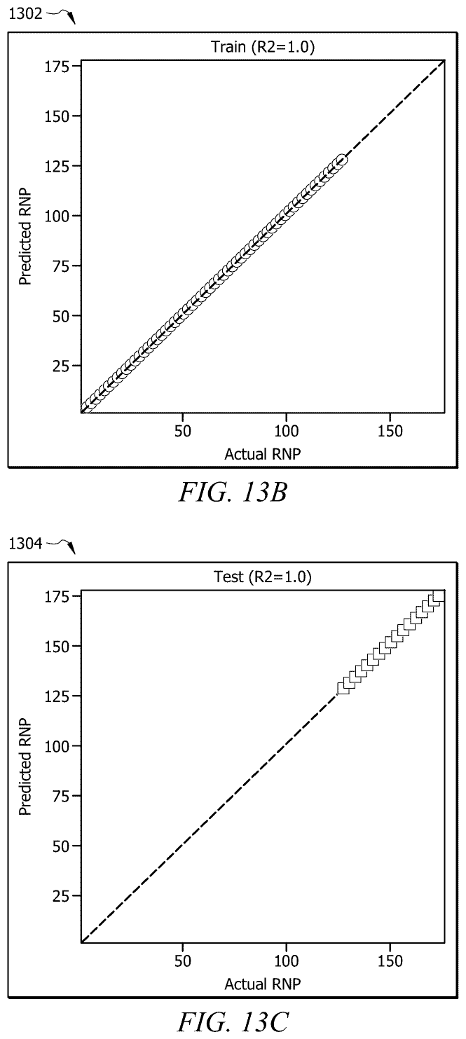

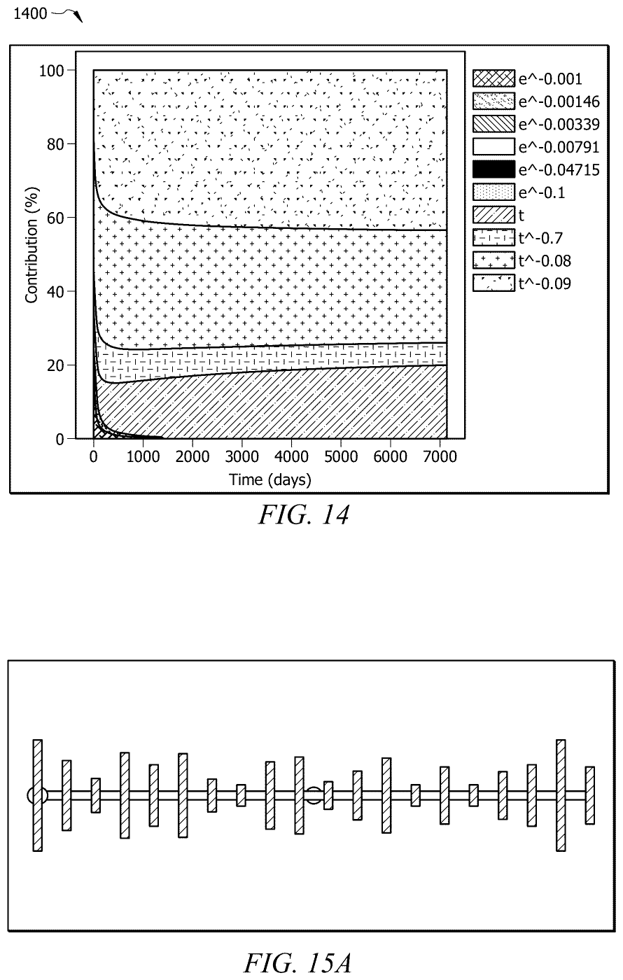

The SNR model was trained using a feature library of 61 features, including 52 based on Wattenbarger's equation and the other nine corresponding to t^{m} with m ranging from 0.1-0.9 in 0.1 incremental, as explained above in Table 2 and Table 3. The outcomes derived from SINDy corresponding to the actual data are illustrated in plots 1200, 1202, 1204, 1300, 1302, and 1304 of FIGS. 12A-13C, respectively. The model may be developed by training on 75% of the available dataset. The chosen features and their corresponding contributions, as shown in plot 1400 in FIG. 14, may be consistent with the RNP pattern, indicating a consistent and gradual change in slope that persists at a level greater than 0.7 for the majority of the production history, before transitioning into a unit slope. This shows the ability of the algorithm to pick complex non-linear fluid flow behavior that cannot be limited to a single slope line and using a characteristic equation for that slope.

### Example 3—Unequal Fracture Lengths with Finite Conductivity in a Closed Boundary Reservoir

The third example involved a representation of a complex fracture network that reflects a real-life situation where fracture lengths may vary due to factors such as geo-mechanical effects, operational limitations, and/or incomplete well completion between stages. Additionally, finite conductivity fractures have been taken into account, which may lead to early sub-radial flow with area-to-flow gradually increasing in certain fractures, in combination with linear to transitional to stimulated reservoir volume flow. As a result, performing a conventional RTA to analyze flow regimes may not be feasible, as multiple flow regimes occur simultaneously.

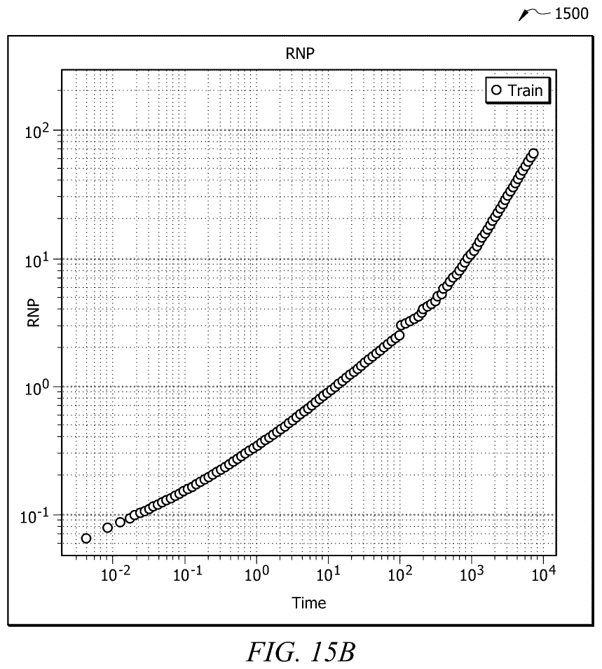

FIG. 15A illustrates the fracture model with a closed reservoir boundary, that may be simulated for a period of 20 years. The corresponding RNP profile on a log-log plot 1500 is shown in FIG. 15B, which depicts variable slopes associated with such fracture complexity.

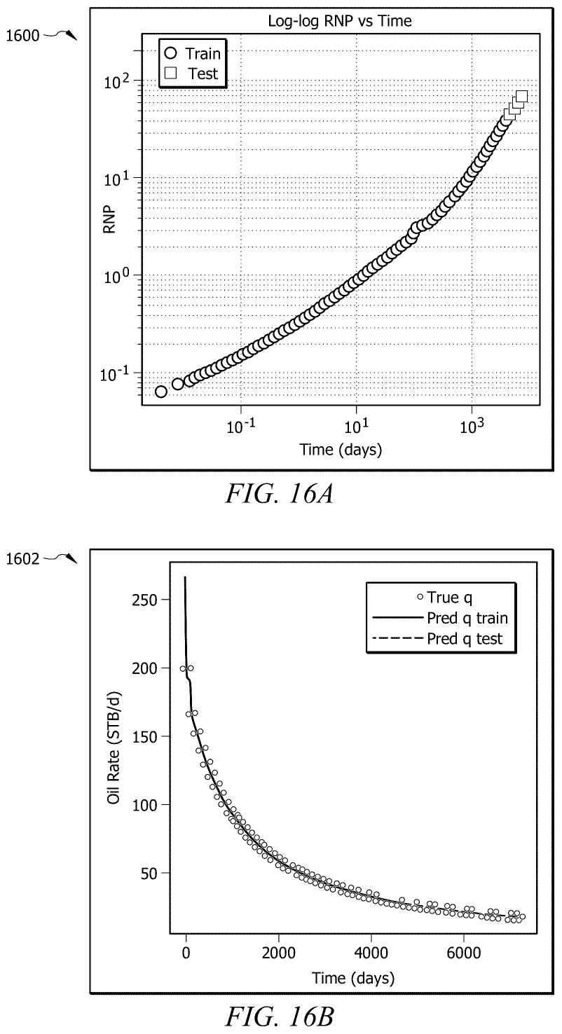

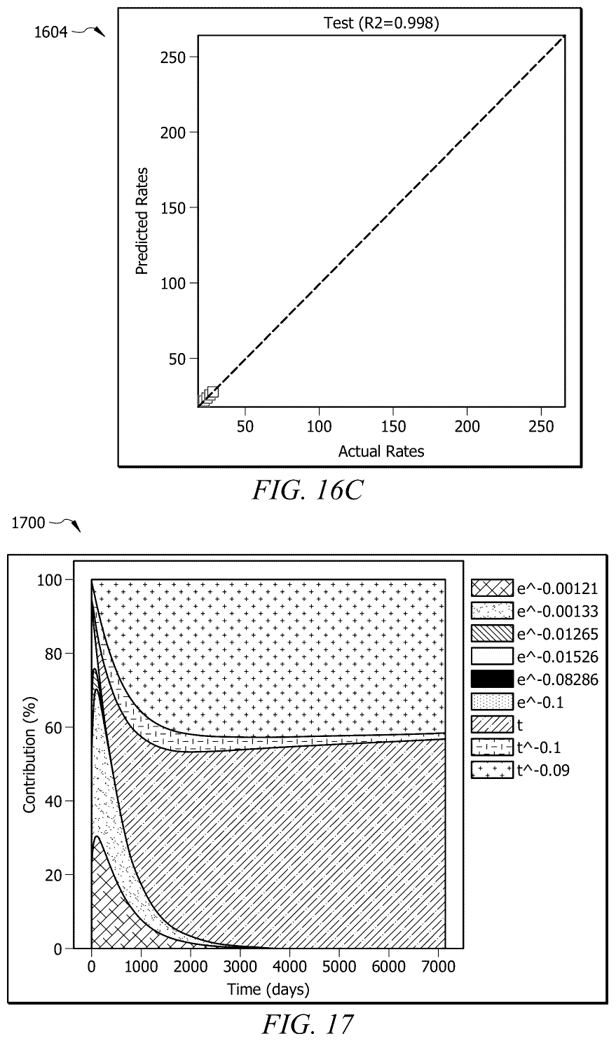

The plots 1600, 1602, and 1604 of FIGS. 16A-16C, respectively, illustrate the RNP for both the training and testing cases, along with the corresponding rate profile, which may be compared to the actual rates. The model may be trained on 75% of the available data set. The match between the predicted and actual rates may be accurate, demonstrating the SNR model's capability to identify the significant features in a way that depicts the complete history and maintains accuracy for future predictions. FIG. 17 illustrates how the importance of features changes over time in plot 1700. For the initial 500 days, the flow may be dominated by a combination of exponential terms and a time slope of 0.1, which contributes to the sub-radial flow profile. This may be followed by linear flow, which gradually transitions into SRV flow, where the dominant terms are t and t^{0.9} are dominant.

However, the workflow may be computationally efficient and scalable, making it suitable for routine use on a daily basis or whenever rate data may be available. The method may not require any manual intervention or human interpretation. In unconventional reservoirs, flow regimes may tend to persist for long periods, making the proposed workflow suitable for most time periods, particularly for short-term forecasts. As the model may be automatically scaled to run regularly, forecast accuracy may be expected to improve as more data becomes available for previously unseen flow regimes.

### Example 4—Synthetic Case: Secondary Phase GOR Forecast

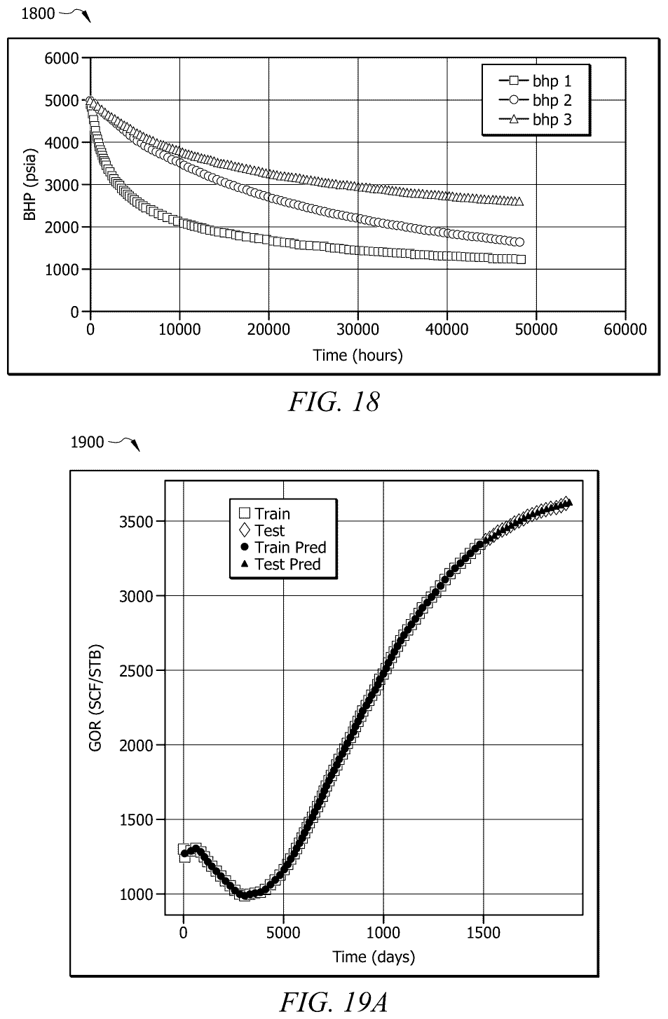

The fourth example involved applying the proposed methodology to forecast GOR, from Equation (6), for saturated oil in an unconventional reservoir which may then be used to predict gas rates by simply multiplying the forecasted GOR with forecasted oil rates. Here, in a synthetic model with the well located in a closed boundary reservoir and with uniform fracture spacing, the sensitivity scenario for the same well for different BHP profiles (low, mid, and high cases) may be determined, as shown in plot 1800 in FIG. 18, to illustrate the ability of the model to capture GOR trends due to varying operating conditions.

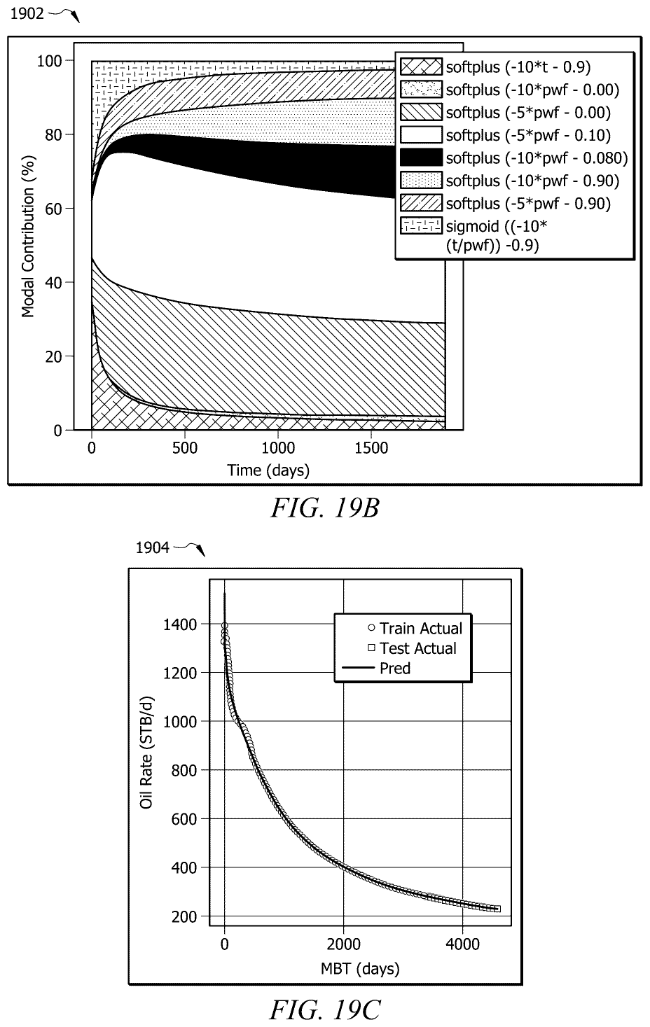

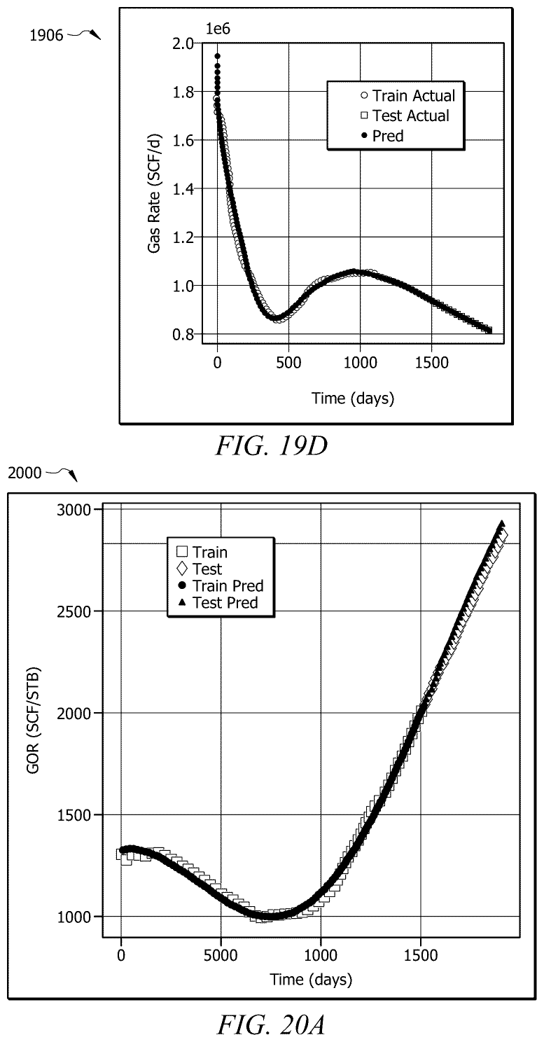

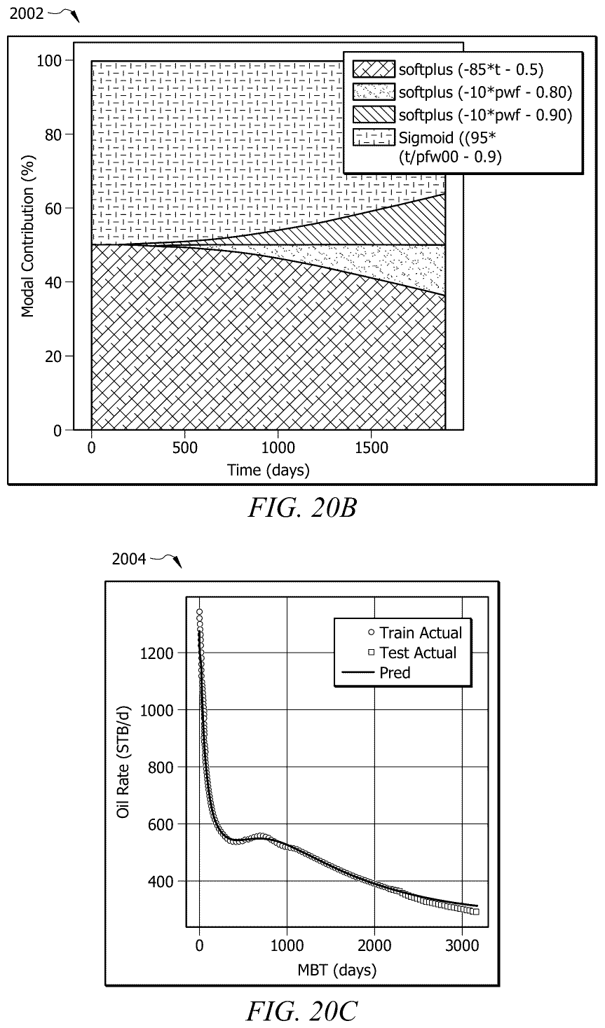

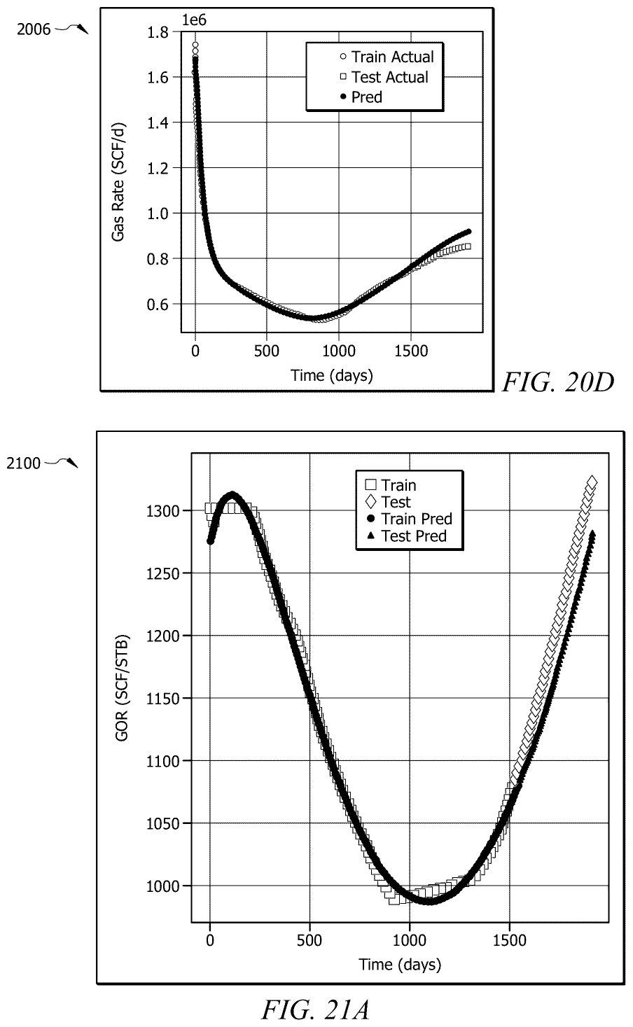

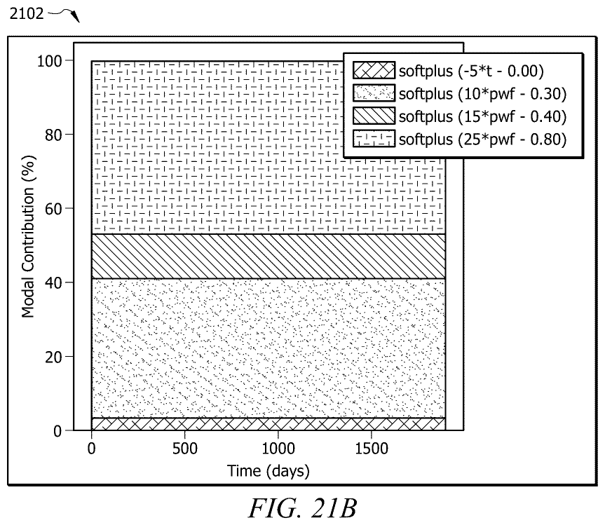

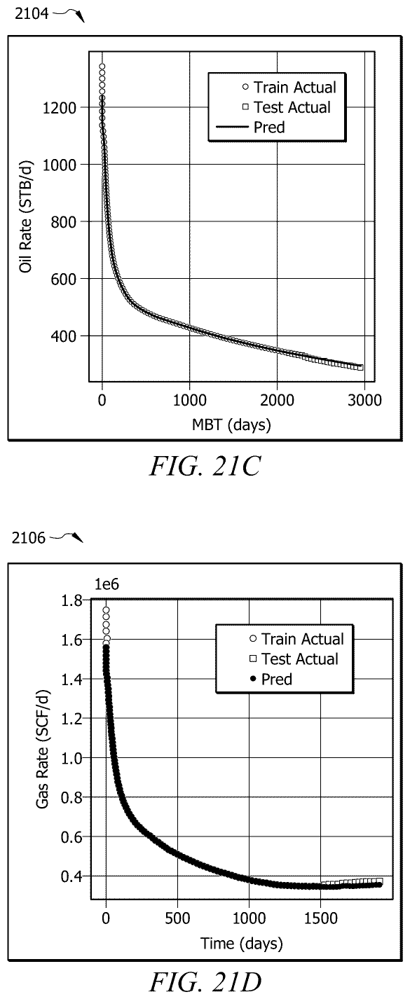

FIGS. 19A-21D illustrate the plots showing the GOR forecast profile for each of the aforementioned different BHP profiles. FIGS. 19A, 20A, and 21A show a plot 1900, 2000, and 2100, respectively, for the training and test periods. FIGS. 19B, 20B, and 21B show a plot 1902, 2002, and 2102, respectively, having feature contribution with respect to time. In each case, the GOR model predictions matches closely to the actual data during a forecast period. FIGS. 19C, 20C, and 21C show a plot 1904, 2004, and 2104, respectively, using the RNP model to forecast the oil rates for each case. Finally, with both the GOR forecasts and oil forecasts, the gas rates may be predicted, as shown in plots 1906, 2006, and 2106 in FIGS. 19D, 20D, and 21D, respectively. It may be determined that the accuracy on gas forecasts for each BHP scenario may be high when compared to actual data (within 4% median absolute percentage error (“MedAPE”), thus showing that the proposed modeling strategy and the library of features may be able to correctly capture the underlying dynamics associated with the flow of secondary phase depending on the operating conditions. The oil rate, GOR, and gas rate median absolute percentage error during forecast are show below in Table 7.

TABLE 7

| | Oil Rate | GOR | Gas Rate |
|---|---|---|---|
| | (MedAPE) | (MedAPE) | (MedAPE) |
| Low BHP | 0.22% | 2% | 0.1% |
| Mid BHP | 2.5% | 10% | 4% |
| High BHP | 0.97% | 5.8% | 2% |

### Example 5—Field Case: Gas Well

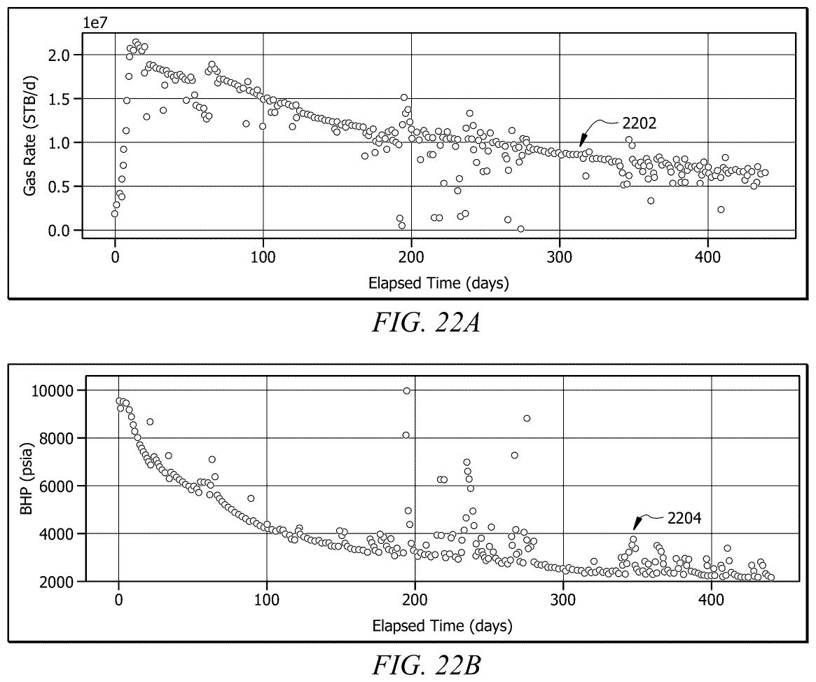

The fifth example involved a field case for an onshore U.S. basin well with dry gas as the primary producing phase. FIGS. 22A and 22B show plots of the gas rates and corresponding BHPs calculated for the well. In this example, a real field case is considered for an onshore US basin well with dry gas as the primary producing phase. FIGS. 22A and 22B show the gas rates 2202 and corresponding BHPs 2204, respectively, calculated for the well under consideration.

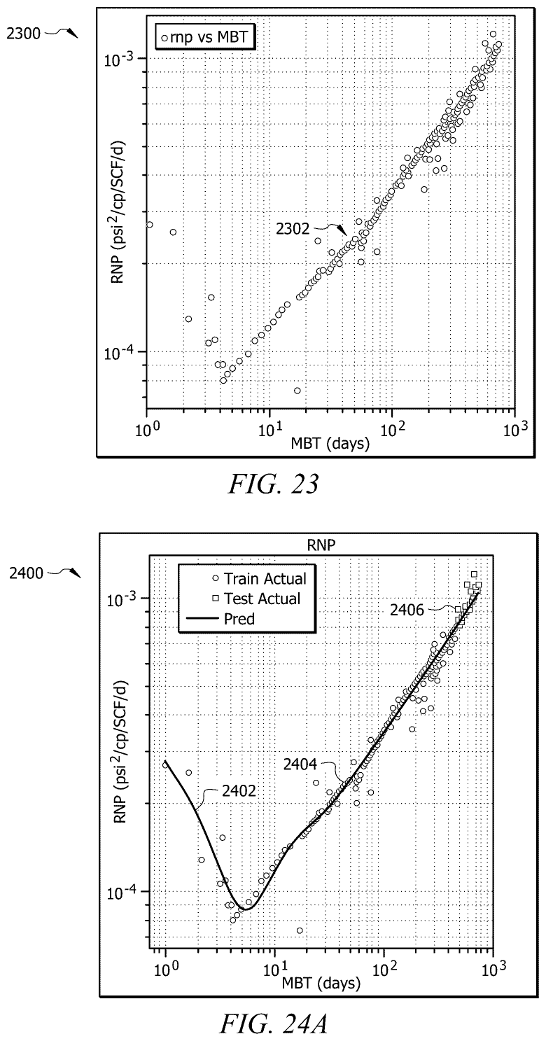

Since field scenarios may not be expected to produce smooth rate profiles as observed in the synthetic models, it may be expected for the RNP vs. time trend to show noise. Using RNP as a function of material balance time (“MBT”) may effectively handle the noisy data for hybrid SINDy analysis. MBT may normalize RNP by providing a constant-rate equivalent for variable flow rate/variable pressure drop data. The plot of RNP vs. MBT may be shown in FIG. 23. FIG. 23 illustrates a plot 2300 of gas RNP vs material balance time (MBT) for the gas well, in accordance with certain embodiments. Since real field scenarios are not expected to produce smooth rate profiles as observed in the synthetic models, it is expected for the RNP vs. time trend 2302 to show these impacts of noise. Using RNP as a function of MBT effectively handles the noisy data for hybrid SNR analysis. MBT normalizes RNP by providing a constant-rate equivalent for variable flow rate/variable pressure drop data. In the present embodiment for gas wells, RNP may be calculated using pseudo pressures as defined in Equation (13).

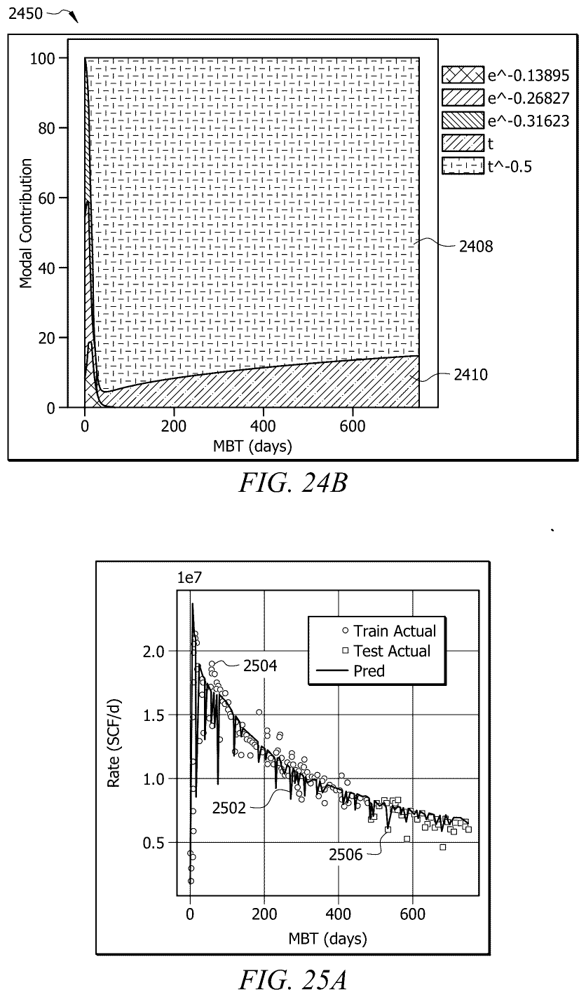

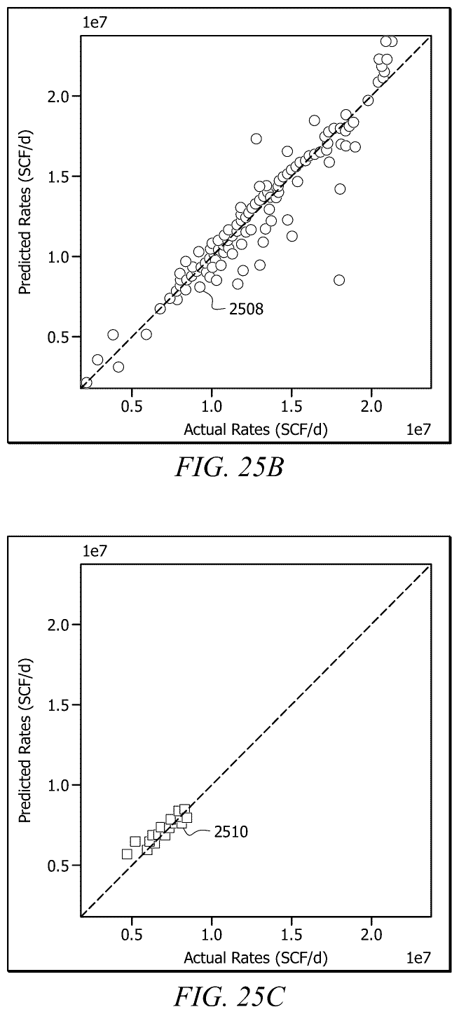

FIG. 24A illustrates a plot 2400 of predicted and actual gas RNP with respect to MBT for the gas well, in accordance with certain embodiments. FIG. 24B illustrates a plot 2450 showing coefficient contribution with MBT for the gas well, in accordance with certain embodiments. The observed samples were split into 75% training data 3204 and 25% test data 2406. The training samples 2404 are used to train a seventh model as formulated with physics inspired features. The resultant model RNP predictions 2402 are then used to predict rates for the actual BHPs implemented during the test phase to compare against actual rates. FIG. 24B shows the feature contribution map includes a dominant t^{0.5} feature 2408 during a major part of the training period and gradually increasing contribution from the linear t feature 2410. In some embodiments, the time features use MBT function of time. This example shows how the resulting RNP equation indicates at any given time multiple flow regimes can co-exist. FIGS. 25A-25C illustrate plots of a predicted and an actual gas rate vs. MBT (FIG. 25A), and predicted vs. actual gas rate data for a machine learning training portion (FIG. 25B) and a test portion (FIG. 25C), in accordance with certain embodiments. FIG. 25A shows the training rate data 2504, test rate data 2506, and predicted rate data 2502. FIG. 25B shows a good consistency 2508 in a cross plot of the predict oil rate values and the actual oil rate data in the machine learning training portion. FIG. 25C shows a consistency 2510 in a cross plot of the predict oil rate values and the actual oil rate data in the test portion. The results indicate accuracy of the hybrid SINDy model to predict gas rates for the operated BHP. Table 8 below MedAPEs for the predicted rates.

TABLE 8

| Train Gas Rates MedAPE | Test Gas Rates MedAPE |
|---|---|
| 2.5% | 3.4% |

### Example 6—Field Case: Oil Well with High Water Cut

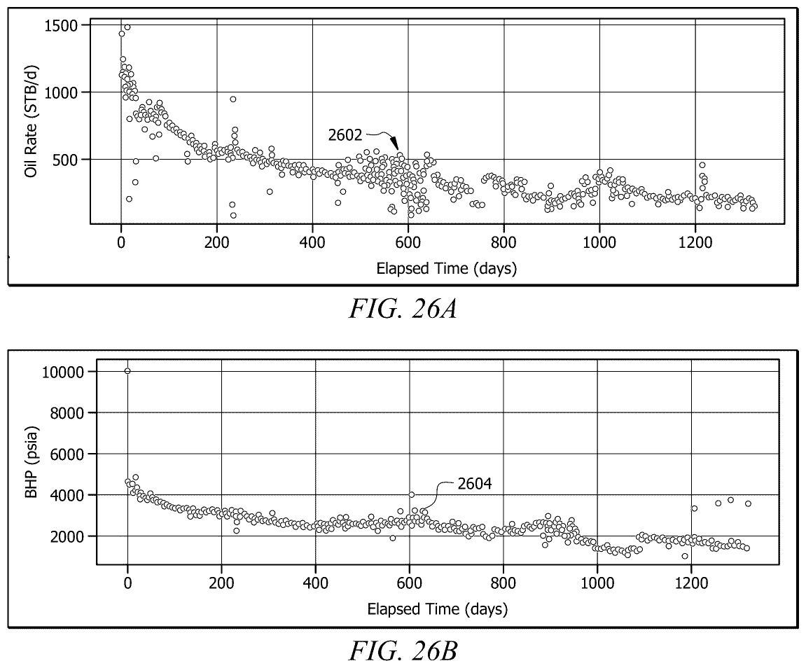

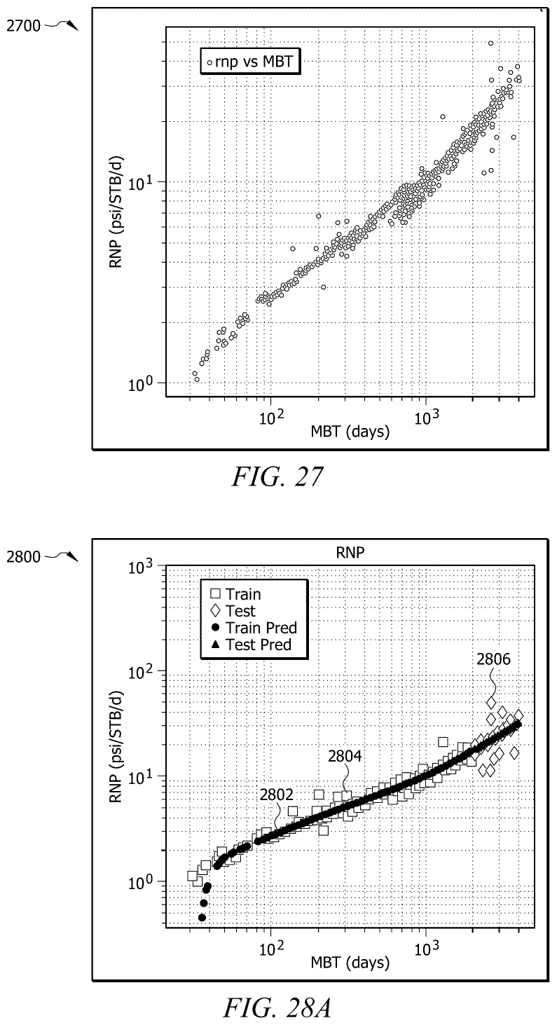

The sixth example involved another field case for a well in the U.S. onshore basin with primary oil phase production that has a water cut ranging around 90%. FIGS. 26A and 26B show the oil rate 2602 and BHP 2604 for the well, and FIG. 27 illustrates the RNP vs MBT on a log-log plot 2700 that may be used to sample the train (i.e., the 75%) and test (i.e., the 25%) sets.

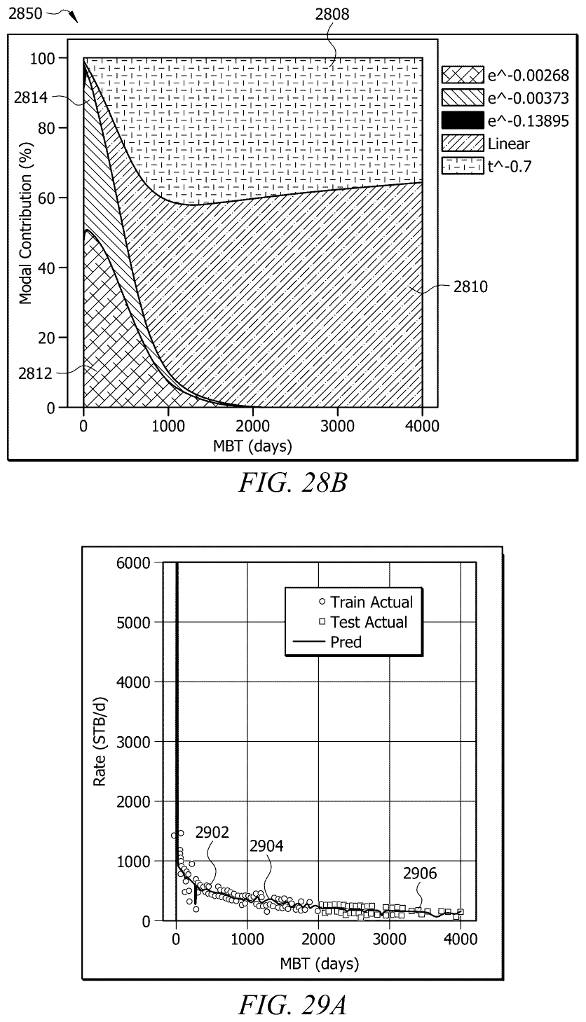

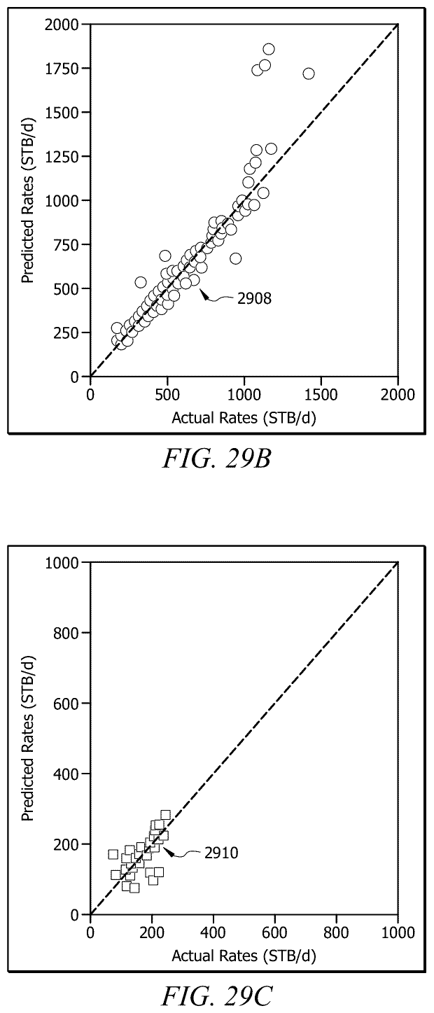

The present embodiment involves a multi-phase case with predominantly liquid production. It may be useful to derive both liquid and oil rate predictions using hybrid SINDy since the formulation may be generic to apply to any phase independently and be able to identify the underlying governing equations for any phase. First, hybrid SINDy was applied to oil RNP, as seen in FIG. 28A, and subsequently the oil rates are predicted on 25% of the data set over new future MBT values, as seen in FIGS. 29A-29C. Here, the first 30 points of the production history were filtered out to remove noisy data due to issues with surface measurements initially. FIG. 28B shows the model contribution plot with MBT that may indicate coexistence of multiple flow regime signatures through dominant t^{0.7} feature and linear feature of MBT. The exponential terms may dominate initially, which then decrease after approximately 2000 MBT days. The ability of the algorithm to determine simultaneous flow profiles may also be evident from non-linearities that seem to exist in the RNP plot rather than what a classical RTA workflow would have done by fitting straight lines with certain pre-defined slopes to it.

FIG. 28A illustrates a plot 2800 of predicted and actual oil RNP with respect to MBT for the oil well, in accordance with certain embodiments. The proposed hybrid SNR method is used to determine an eighth model by using the actual oil RNP data for the machine learning training portion 2804 and the actual oil RNP data for the test portion 2806. Thus, the proposed hybrid SNR method may be used to predict oil RNP estimates 2802 based on the eighth model.

FIG. 28B illustrates a plot 2850 showing coefficient contribution with MBT for oil production from the oil well, in accordance with certain embodiments. The feature contribution map indicates coexistence of multiple flow regime signatures through a dominant t^{0.7} feature 2808 and a linear feature 2810 of MBT. The exponential terms 2812 are dominating initially, which die down after approximately 2000 MBT days. The ability of the algorithm to pick up simultaneous flow profiles is also evident from non-linearities that seem to exist in the RNP plot rather than what a classical RTA workflow would have done by fitting straight lines with certain pre-defined slopes to it.

FIGS. 29A-29C illustrate plots of a predicted and an actual oil rate vs. MBT (FIG. 29A), and predicted vs. actual oil rate data for a machine learning training portion (FIG. 29B) and a test portion (FIG. 29C), in accordance with certain embodiments. FIG. 29A shows the training rate data 2904, test rate data 2906, and predicted rate data 2902. FIG. 29B shows a good consistency 2908 in a cross plot of the predict oil rate values and the actual oil rate data in the machine learning training portion. FIG. 29C shows a consistency 2910 in across plot of the predict oil rate values and the actual oil rate data in the test portion. FIGS. 29B and 29C show accuracy of the model to predict gas rates for the operated BHP. In some embodiments, the first 30 points of the production history are filtered out to remove noisy data due to issues with surface measurements initially.

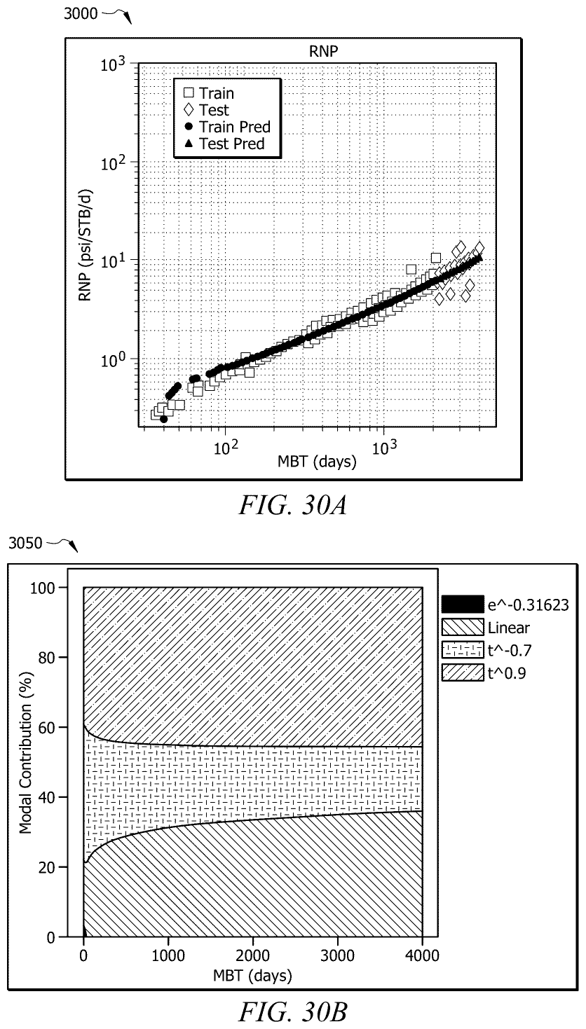

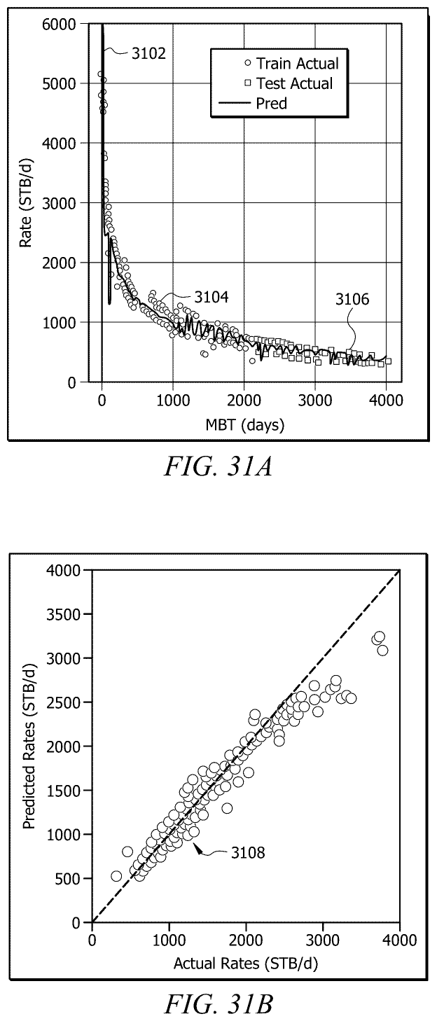

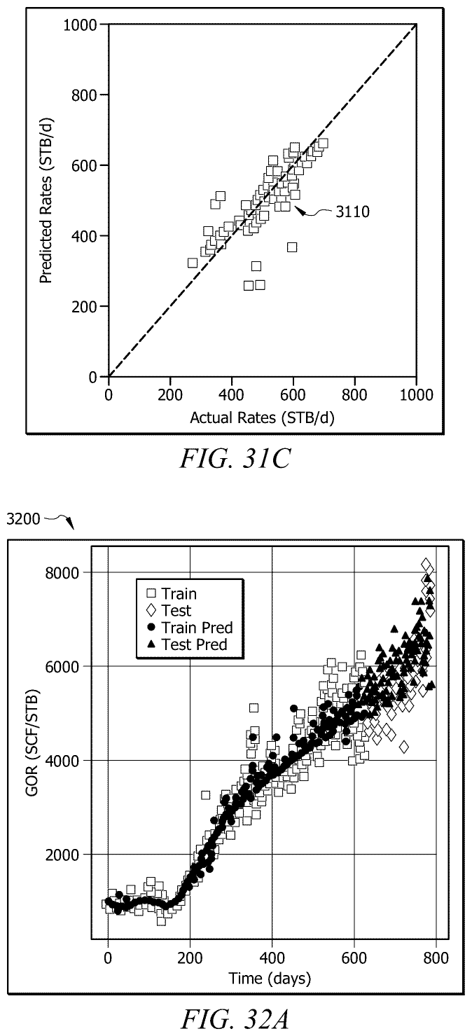

Similarly, the same workflow was then applied to liquid RNP vs. liquid MBT dataset. The actual liquid RNP profile and the predicted RNP using hybrid SINDy may be shown in plot 3000 in FIG. 30A along with the feature contribution plot 3050 with MBT in FIG. 30B. As shown, the RNP profile may be dominated by sublinear-linear flow regime that simultaneously exist, and there may be just one exponential term selected by the algorithm that has almost negligible contribution decaying in the beginning. Based on the predicted RNP, liquid rates may be predicted for the operating BHP profile and compared against actual rates as shown in FIGS. 31A-31C. FIGS. 31A-31C illustrate plots of a predicted and an actual liquid rate vs. MBT (FIG. 31A), and predicted vs. actual liquid rate data for a machine learning training portion (FIG. 31B) and a test portion (FIG. 31C), in accordance with certain embodiments. FIG. 31A shows the training rate data 3104, test rate data 3106, and predicted rate data 3102. FIG. 31B shows a good consistency 3108 in a cross plot of the predict liquid rate values and the actual liquid rate data in the machine learning training portion. FIG. 31C shows a consistency 3110 in a cross plot of the predict liquid rate values and the actual liquid rate data in the test portion. FIGS. 31B and 31C show accuracy of the model to predict liquid rates for the operated BHP. Based on the predicted RNP, liquid rates are predicted for the operating BHP profile and compared against actual rates as shown in FIGS. 31A-31C. The median absolute percentage error for both oil and liquid rates for train and test sets are shown below in Table 9.

TABLE 9

| | Train Rates MedAPE | Test Rates MedAPE |
|---|---|---|
| Oil | 4.7% | 3.8% |
| Liquid | 6.0% | 4.8% |

### Example 7—Field Case: Multiphase Forecast

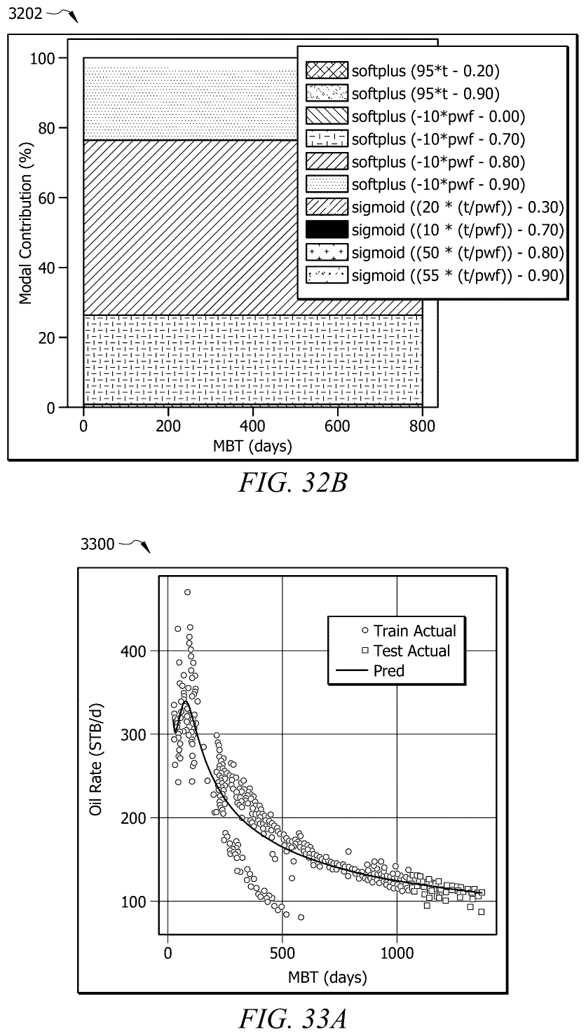

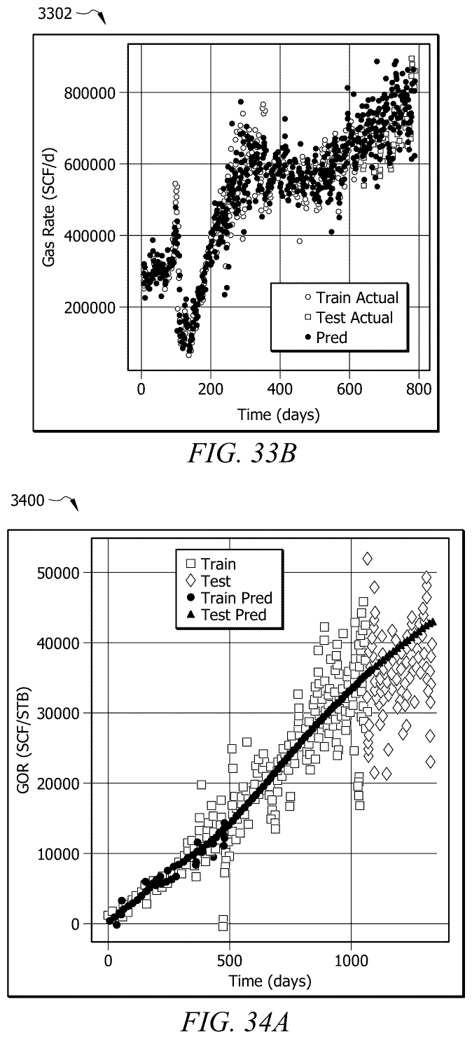

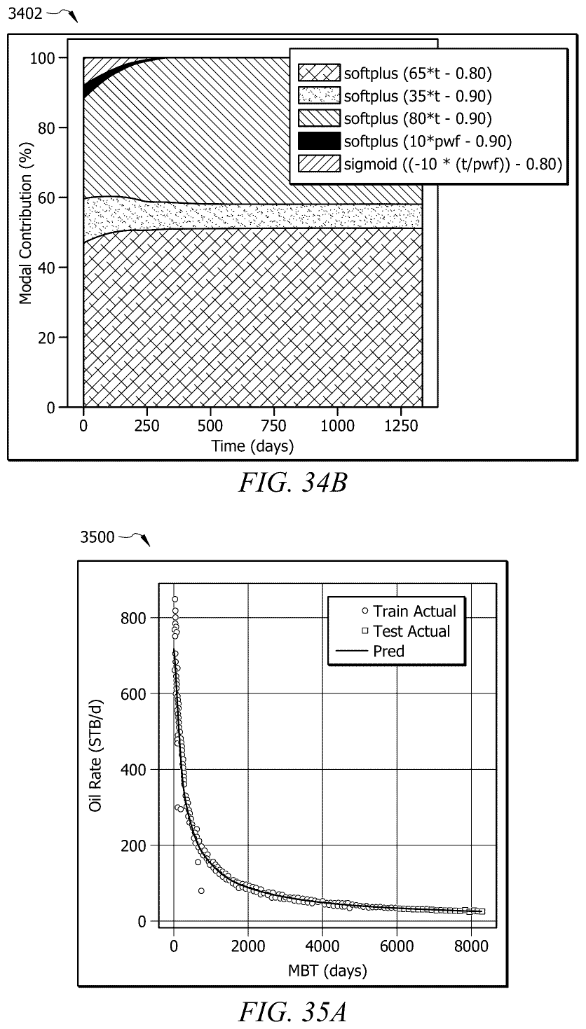

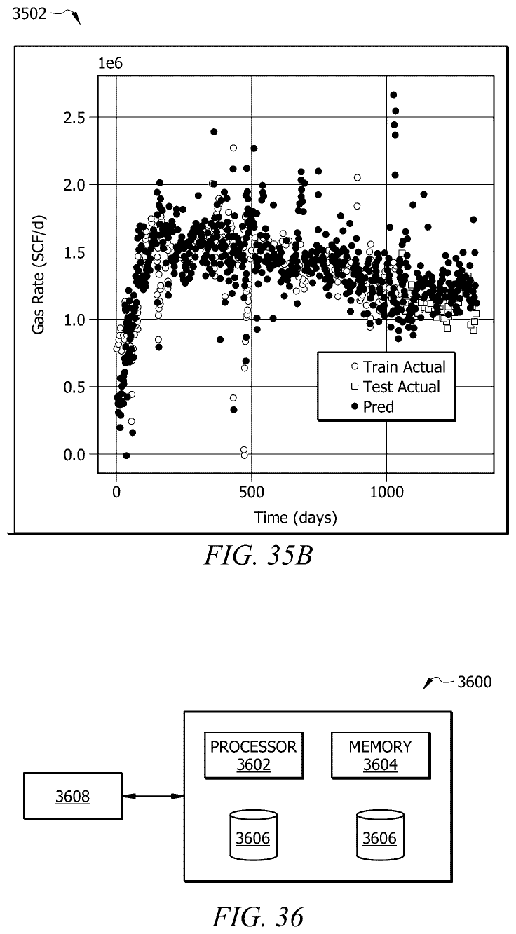

The seventh example involved another field case for two wells in the U.S. onshore basin with primary oil phase production and GOR increase within the first few months of production. The same procedure was followed as described in the synthetic case with multiphase flow. The GOR model was trained using the feature library of time and BHP on 75% of the history and the remaining 25% may be used for testing. FIG. 32A and FIG. 34A illustrate plots 3200 and 3400 having the predicted GOR against actual data during training and testing period. FIG. 32B and FIG. 34B illustrate plots 3202 and 3402 showing the feature importance plot for GOR model for each case that shows each well has a different feature set, which may be impacted by inherent reservoir properties, PVT conditions, and/or operating conditions. Then, the RNP model was used to predict the oil rates which, with the forecasted GOR, are used to predict gas rates, as shown in in plots 3300 and 3302 in FIGS. 33A-33B and in plots 3500 and 3502 in FIGS. 35A-35B for the two wells. Accuracy for both the oil and gas forecasts may be obtained suggesting the model's ability to generalize across varying complexities, as provided below in Table 10.

TABLE 10

| | Oil Rate | GOR | Gas Rate |
|---|---|---|---|
| | (MedAPE) | (MedAPE) | (MedAPE) |
| Well 1 | 2.6% | 10.9% | 7.3% |
| Well 2 | 1.1% | 10.3% | 9% |

The present disclosure provides systems and methods using a hybrid SNR method to forecast multi-phase flow in MFHWs in unconventional reservoirs by establishing relationships for primary phase flow rates and GOR with BHP and time. This method may employ a library of functions to capture the dominant fluid flow behaviors in unconventional reservoirs. It may be demonstrated in the above examples that the hybrid SNR method may effectively capture fluid flow behavior in complex and non-uniform fractures that exhibit complex diagnostic behavior due to multiple concurrent dynamics that cannot be explained by analytical equations.

FIG. 36 illustrates a block diagram of an exemplary control unit 3600 in accordance with some embodiments of the present disclosure. In certain example embodiments, control unit 3600 may be configured to create and maintain one or more databases 3606 that include information concerning one or more reservoirs or reservoir models. In certain example embodiments, control unit 3600 may be configured to use information from database(s) 3606 to train one or many machine learning algorithms, including, but not limited to, artificial neural network, random forest, gradient boosting, support vector machine, kernel density estimator, and any combination thereof. In some embodiments, control unit 3600 may include one more processors, such as processor 3602. Processor 3602 may include, for example, a microprocessor, microcontroller, digital signal processor (DSP), application specific integrated circuit (ASIC), or any other digital or analog circuitry configured to interpret and/or execute program instructions and/or process data. In some embodiments, processor 3602 may be communicatively coupled to memory 3604. Processor 3602 may be configured to interpret and/or execute non-transitory program instructions and/or data stored in memory 3604. Program instructions or data may constitute portions of software for carrying out estimations of reservoir or well performance characteristics, as described herein. Memory 3604 may include any system, device, or apparatus configured to hold and/or house one or more memory modules; for example, memory 3604 may include read-only memory, random access memory, solid state memory, or disk-based memory. Each memory module may include any system, device or apparatus configured to retain program instructions and/or data for a period of time (e.g., computer-readable non-transitory media).

Although control unit 3600 is illustrated as including two databases 3606, control unit 3600 may contain any suitable number of databases and machine learning algorithms. Control unit 3600 may be communicatively coupled to one or more displays 3608 such that information processed by control unit 3600 may be conveyed to operators at or near the well or may be displayed at a location offsite.

Modifications, additions, or omissions may be made to FIG. 36 without departing from the scope of the present disclosure. For example, FIG. 36 shows a particular configuration of components for control unit 3600. However, any suitable configurations of components may be used. For example, components of control unit 3600 may be implemented either as physical or logical components. Furthermore, in some embodiments, functionality associated with components of control unit 3600 may be implemented in special purpose circuits or components. In other embodiments, functionality associated with components of control unit 3600 may be implemented in a general purpose circuit or components of a general purpose circuit. For example, components of control unit 3600 may be implemented by computer program instructions.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

A number of examples have been described. Nevertheless, it will be understood that various modifications can be made. Accordingly, other implementations are within the scope of the following claims.

What is claimed is:

1. A method of determining fluid flow dynamics in a well, comprising:
determining a first set of basis functions that is dependent on time;
conducting a sparse identification of nonlinear dynamics (SINDy) evaluation based on the first set of basis functions to determine a rate normalized pressure for a primary phase rate;
forecasting the primary phase rate based, at least in part, on the rate normalized pressure for a plurality of bottomhole pressure measurements from the well;
determining a gas oil ratio based, at least in part, on a second set of basis functions that are dependent on time and bottomhole pressure; and
calculating a secondary phase rate based, at least in part, on the gas oil ratio and the forecasted primary phase rate.

2. The method of claim 1, wherein the first set of basis functions is associated with a flow regime occurring during a production phase after flowback of the well.

3. The method of claim 1, wherein the gas oil ratio is further determined based, at least in part, on one or more factors selected from the group consisting of: a degree of undersaturation; one or more fracture parameters; gas-oil pressure, volume, and temperature (PVT) properties; a relative permeability; a bubble point suppression effect; a duration of a transient-flow regime; and any combination thereof.

4. The method of claim 1, further comprising determining a median absolute percentage error for each of the forecasted primary phase rate, the gas oil ratio, and the secondary phase rate.

5. The method of claim 1, further comprising normalizing the rate normalized pressure by material balance time.

6. The method of claim 1, wherein the second set of basis functions comprises a softplus function and a sigmoid function.

7. The method of claim 6, wherein each of the second set of basis functions comprises a first coefficient and a second coefficient determined by modeling a dataset.

8. An apparatus for modeling a gas oil ratio for a well in an unconventional reservoir, comprising:
a memory operable to:
store a first set of basis functions; and
store a second set of basis functions; and
a processor, operably coupled to the memory, configured to:
determine the first set of basis functions being dependent on time;
conduct a sparse identification of nonlinear dynamics (SINDy) evaluation based on the first set of basis functions to determine a rate normalized pressure for a primary phase rate;
forecast the primary phase rate based, at least in part, on the rate normalized pressure for a plurality of bottomhole pressure measurements;
determine a gas oil ratio based on the second set of basis functions that are dependent on both time and bottomhole pressure; and
calculate a secondary phase rate based on the determined gas oil ratio and the forecasted primary phase rate.

9. The apparatus of claim 8, wherein the first set of basis functions is associated with a flow regime occurring during a production phase after flowback of the well.

10. The apparatus of claim 8, wherein the gas oil ratio is further determined based, at least in part, on one or more factors selected from the group consisting of: a degree of undersaturation; one or more fracture parameters; gas-oil pressure, volume, and temperature (PVT) properties; a relative permeability; a bubble point suppression effect; a duration of a transient-flow regime; and any combination thereof.

11. The apparatus of claim 8, wherein the processor is further configured to:
determine a median absolute percentage error for each of the forecasted primary phase rate, the gas oil ratio, and the secondary phase rate.

12. The apparatus of claim 8, wherein the processor is further configured to:
normalize the rate normalized pressure by material balance time.

13. The apparatus of claim 8, wherein the second set of basis functions comprises a softplus function and a sigmoid function.

14. The apparatus of claim 13, wherein each of the second set of basis functions comprises a first coefficient and a second coefficient determined by modeling a dataset.

15. A non-transitory computer-readable medium comprising instructions that are configured, when executed by a processor, to:
determine a first set of basis functions that is dependent on time;
conduct a sparse identification of nonlinear dynamics (SINDy) evaluation based on the first set of basis functions to determine a rate normalized pressure for a primary phase rate;
forecast the primary phase rate based, at least in part, on the rate normalized pressure for a plurality of bottomhole pressure measurements;
determine a gas oil ratio based on a second set of basis functions that are dependent on both time and bottomhole pressure; and
calculate a secondary phase rate based on the determined gas oil ratio and the forecasted primary phase rate.

16. The non-transitory computer-readable medium of claim 15, wherein the first set of basis functions is associated with a flow regime occurring during a production phase after flowback of the well.

17. The non-transitory computer-readable medium of claim 15, wherein the gas oil ratio is further determined based, at least in part, on one or more factors selected from the group consisting of: a degree of undersaturation; one or more fracture parameters; gas-oil pressure, volume, and temperature (PVT) properties; a relative permeability; a bubble point suppression effect; a duration of a transient-flow regime; and any combination thereof.

18. The non-transitory computer-readable medium of claim 15, wherein the instructions are further configured to:
determine a median absolute percentage error for each of the forecasted primary phase rate, the gas oil ratio, and the secondary phase rate.

19. The non-transitory computer-readable medium of claim 15, wherein the instructions are further configured to:
normalize the rate normalized pressure by material balance time.

20. The non-transitory computer-readable medium of claim 15, wherein the second set of basis functions comprises a softplus function and a sigmoid function.
